(19) United States
(12) Patent Application Publication
(10) Pub. No.: US 2014/0065592 A1
(43) Pub. Date: Mar. 6, 2014

(54) INTERACTIVE LEARNING AND PERFORMANCE ENHANCEMENT SYSTEM

(71) Applicant: Carl STRANG, Schenectady, NY (US)

(72) Inventor: Carl STRANG, Schenectady, NY (US)

(73) Assignee: CAPITAL REGION BOCES, Albany, NY (US)

(21) Appl. No.: 13/601,637

(22) Filed: Aug. 31, 2012

(51) Int. Cl. G09B 5/00

(52) U.S. Cl. CPC G09B 5/00
USPC 434/350

(57) ABSTRACT

The present invention comprises a system and method for monitoring participants in an educational environment and comprises: obtaining a set of predefined parameters, obtaining a first data set and a second data set, wherein the first data set comprises standardized summary data relating to the educational environment and the second data set comprises non-standardized granular data relating to the educational environment, converting the second data set into a standardized data set (a third data set) by identifying relationships between a value in the first data set and a value in the second data set, storing the standardized data sets in a consolidated data set on a memory resource, and generating a notification when the data in the consolidated data set satisfies the set of predefined parameters.

### FIELD OF INVENTION

The present invention relates to a system and method for providing secure and configurable access to an online learning and student management system with access levels directed to different roles and different communities within a broad range of educational environments.

### BACKGROUND OF INVENTION

Utilizing data in order to predict and manage student outcomes, reduce the achievement gap between the highest and lowest performers, and ensure that the students within an educational environment maximize their success, is a challenge faced within an educational environment. Due to mandated reporting requirements at the classroom, school, district, and state levels, the quantity and breadth of data relating to a student's activities and performance is large, diverse, and can be difficult to manage and present in a way that is helpful to individuals within the educational environment, to which the data pertains. This information can include, but is not limited to, data specific to the student, the teacher, the classroom, the school, and the district. Accumulating the data, combining the data, interpreting the data, and actually utilizing it for specific goals that are relevant to a given individual within an education environment, are all potentially difficult tasks.

Not only is the quantity of data large and the information diverse, but what is useful to individuals across varied roles is highly customized. For example, the type of information that is important to one individual in a given environment may not be useful to another individual within the same environment or to an individual in a different environment. In this context, useful information is information that crosses a threshold that triggers an action. Thus, what constitutes useful data is both context and role driven.

Consolidating and correlating the data into a comprehensive model assists individuals across varied roles, including but not limited to, School Administrators, Teachers, Parents and/or Students, in varied environments, including, but not limited to, K-12 programs, in assisting students in achieving success in educational environments.

A standard reporting system that offers canned reports to report student achievement does not meet the needs of a school district seeking to predict and manage student outcomes, reduce the achievement gap between the highest and lowest performers, and ensure that the students within an educational environment maximize their success. Standard reports are passive indicators of trends, they do not weigh the information displayed to enable an active approach to shaping future results.

A need exists for a system and method that not only gathers and displays data from multiple sources to individuals within an educational environment, but also is configurable by the end user in order to shape actions taken by individuals to achieve defined and quantifiable outcomes.

A need exists for a system and method that enables individuals within educational environments including, but not limited to, classrooms, buildings, schools, districts, and states, to establish actions that are informed by user-configurable data thresholds.

### SUMMARY OF INVENTION

An object of the present invention is to provide real-time customized data to assist individuals in varied roles within an educational environment to predict and manage student outcomes, reduce the achievement gap between the highest and lowest performers, and assist the students within the educational environment to maximize their academic success.

A further object of the present invention is to provide a system and method to collect and manage data from multiple sources at the student, classroom, district, multi-district, and/or state level and provide customized information to end-users in-real time.

A further object of the present invention is to provide a system and method within configurable thresholds that enables end-users to develop interventions based on critical points leading to, meeting, and exceeding the thresholds.

A further object of the present invention is to trigger interventions utilizing user-configured thresholds in a predominantly automated fashion, i.e., utilizing minimal and/or no manual inputs from a user.

A further object of the present invention is to focus on school and system level data to establish action, targeting instruction and district, building, classroom and individual student goals related to predicting and managing student outcomes, reducing the achievement gap between the highest and lowest performers, and ensuring that students within an educational environment maximize their success.

A further object of the present invention is to provide users with a tool kit of user-configurable options that enable the user to personalize and configure a vast quantity of data so that the information garnered shapes the actions of the user in an educational environment. User-configurable options include, but are not limited to, automated data dashboards, reporting and custom querying tools, and graphically enhanced, proactive, real-time notifications.

The present invention provides a consolidation of data from unlimited and varied sources that when configured and displayed by the apparatus and method are done so in a manner that allows individuals in an academic environment to take predefined actions to reach desired student outcomes. Thus, rather than being an observation-based reporting systems, the present invention lends itself to actions.

The present invention comprises a system and method for monitoring participants in an educational environment, comprising: obtaining a set of predefined parameters, obtaining a first data set and a second data set, wherein the first data set comprises standardized summary data relating to the educational environment and the second data set comprises non-standardized granular data relating to the educational environment, converting the second data set into a standardized data set (a third data set) by identifying relationships between a first value in the first data set and a second value in the second data set, storing the first data set and the third data set in a consolidated data set on a memory resource, and generating a notification when the data in the consolidated data set satisfies the set of predefined parameters.

In an embodiment of the present invention, the consolidated data set comprises a unified data model.

In an embodiment of the present invention, the notification comprises at least one of: a report, an email, an SMS, a text message, and/or an instant message.

In an embodiment of the present invention, the first data set comprises data from the Statewide Data Warehouse.

In an embodiment of the present invention, the second data set comprises data from at least one of: Student Information System, Special Education System, Intervention System, School Lunch System, Transportation System, Formative, Diagnostic & Summative Assessments, Teacher Observations, anecdotal journal comments related to student progress, behavior and reflections, and/or student, parent and teacher performance goals.

In an embodiment of the present invention, the consolidated data set comprises a plurality of modules.

In an embodiment of the present invention, the set of predefined parameters comprise a threshold for the amount of times a given event can occur within a given period of time. In an embodiment of the present invention, this given event comprises one of: an attendance event, a disciplinary event, a test score.

In an embodiment of the present invention, the system and method also comprises obtaining a plurality of data sets comprising non-standardized granular data relating to the educational environment, converting the plurality of data sets to a standardized plurality of data sets wherein the standardized plurality of data sets are generated by identifying relationships between a value in the first data set and a coordinating value in each of the plurality of data sets, and storing the standardized plurality of data sets in the consolidated data set on the memory resource.

### BRIEF DESCRIPTION OF DRAWING

FIG. 1 depicts an embodiment of one or more aspects of the present invention.

FIG. 2 depicts an embodiment of one or more aspects of the present invention.

FIG. 3 depicts an embodiment of one or more aspects of the present invention.

FIG. 4 depicts an embodiment of one or more aspects of the present invention.

FIG. 5 depicts an embodiment of one or more aspects of the present invention.

FIG. 6 depicts an embodiment of one or more aspects of the present invention.

FIG. 7 depicts an embodiment of one or more aspects of the present invention.

FIG. 7a depicts an embodiment of one or more aspects of the present invention.

FIG. 8 depicts an embodiment of one or more aspects of the present invention.

FIG. 9 depicts an embodiment of one or more aspects of the present invention.

FIG. 10 depicts an embodiment of one or more aspects of the present invention.

FIG. 11 depicts an embodiment of one or more aspects of the present invention.

FIG. 12 depicts an embodiment of one or more aspects of the present invention.

FIG. 13 depicts an embodiment of one or more aspects of the present invention.

FIG. 14 depicts an embodiment of one or more aspects of the present invention.

FIG. 15 depicts an embodiment of one or more aspects of the present invention.

FIG. 16 depicts an embodiment of one or more aspects of the present invention.

FIG. 17 depicts an embodiment of one or more aspects of the present invention.

FIG. 18 depicts an embodiment of one or more aspects of the present invention.

FIGS. 19a-b depicts an embodiment of one or more aspects of the present invention.

FIG. 20 depicts an embodiment of one or more aspects of the present invention.

FIG. 21 depicts an embodiment of one or more aspects of the present invention.

FIG. 22 depicts an embodiment of one or more aspects of the present invention.

FIG. 23 depicts an embodiment of one or more aspects of the present invention.

FIG. 24 depicts an embodiment of one or more aspects of the present invention.

FIG. 25 depicts an embodiment of one or more aspects of the present invention.

FIG. 26 depicts an embodiment of one or more aspects of the present invention.

FIG. 27 depicts an embodiment of one or more aspects of the present invention.

FIG. 28 depicts an embodiment of one or more aspects of the present invention.

FIG. 29 depicts an embodiment of one or more aspects of the present invention.

FIG. 30 depicts an embodiment of one or more aspects of the present invention.

FIG. 31 depicts an embodiment of one or more aspects of the present invention.

FIG. 32 depicts an embodiment of one or more aspects of the present invention.

FIG. 33 depicts an embodiment of one or more aspects of the present invention.

FIG. 34 depicts an embodiment of one or more aspects of the present invention.

FIG. 35 depicts an embodiment of one or more aspects of the present invention.

FIG. 36 depicts an embodiment of one or more aspects of the present invention.

FIG. 37 depicts an embodiment of one or more aspects of the present invention.

FIG. 38 depicts an embodiment of one or more aspects of the present invention.

FIG. 39 depicts an embodiment of one or more aspects of the present invention.

FIG. 40 depicts an embodiment of one or more aspects of the present invention.

FIG. 41 depicts an embodiment of one or more aspects of the present invention.

FIG. 42 depicts an embodiment of one or more aspects of the present invention.

FIG. 43 depicts an embodiment of one or more aspects of the present invention.

### DETAILED DESCRIPTION OF THE INVENTION

The present invention provides a system and method for providing secure and configurable access to an online learning management system directed to users in different roles and different communities over a broad range of educational environments. The present system and method enable users to establish actions that are informed when data aggregated and consolidated through the present system and method reaches predefined data thresholds/benchmarks. By aggregating data from disparate sources into a unified data model, the system and method provides users with the ability to utilize a comprehensive data set to predict and manage student outcomes, reduce the achievement gap between the highest and lowest performers, and assist the students within the educational environment to maximize their academic success.

Members of the educational community maintain an active role in the success of students and other individuals by utilizing thresholds/benchmarks within the system. The diversity and quantity of the data allows the establishment of thresholds based on any type of criteria as established by the district, school or user. Predefined thresholds include, but are not limited to, a given number or certain type of absences, discipline referrals, test scores, and/or marking period averages in general and/or over a given time period. For example, thresholds are set on a nation-wide, state-wide, district-wide, school-wide, class/section, teacher, and/or student specific basis. In embodiments of the present invention, thresholds can be established by a System (Administrator) or by individual user (teacher, staff, administrator, parent, student), or all of the above. A single implementation of the invention can include one or multiple thresholds.

When a given threshold is met, the system and method generates a notification. A notification sent by an embodiment of the system includes, but is not limited to, a report, an email, an SMS, a text message, and/or an instant message. A specific report indicating how/why that student, class, building, etc. has passed the threshold can be included in a notification. In parent-specific notifications, parent contact information can be included.

The predefined thresholds within embodiments of the system assist users in predicting and managing student outcomes. The notifications assist users to In focusing on students who might already be below pre-determined, grade-level benchmarks, and working within the growth model, as enumerated by APPR. Through this identification, teachers have the ability to work with groups and individual students to help target and differentiate instruction to best meet their needs.

Utilization of the system and method reduces the achievement gap between the highest and lowest performers. Embodiments of the system work to aggregate data from multiple sources, allowing education professionals the ability to hone in on specific student deficiencies. Students are also assisted in maximizing their academic success because superintendents, principals, teachers, students and parents use the system and method to work collaboratively on monitoring student progress toward meeting individual student goals/plans.

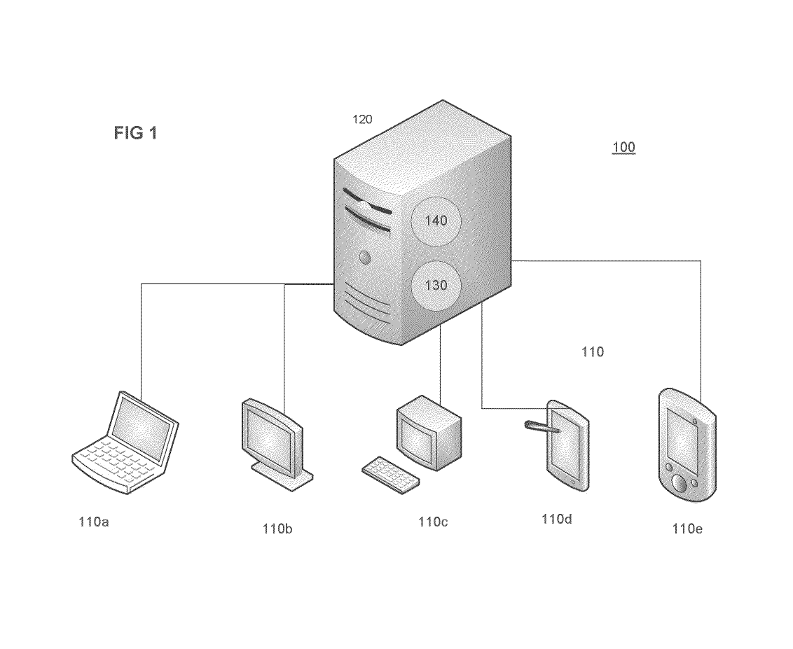

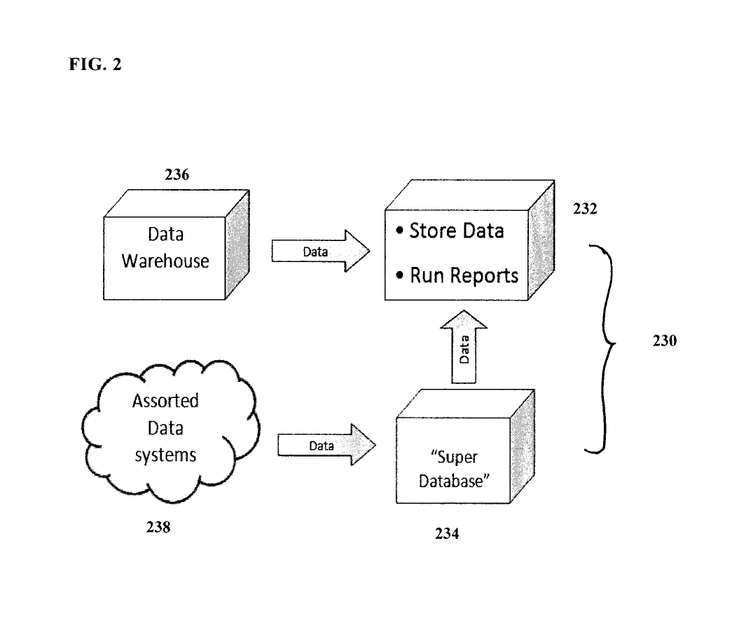

FIG. 1 is a technical architecture 100 utilized by an embodiment of the present invention. User terminals 110a-110e represent various terminals utilized by users of the system to access information pertaining to students within a given learning environment and to tools with which to configure and utilize the information from a user perspective. The information, which includes but is not limited to, reports, alerts, bulletins, and general announcements, is displayed in customized graphical user interfaces (GUIs) on the various user terminals 110a-110e. End user tools, including but not limited to, automated data dashboards, reporting and custom querying tools, and/or graphically enhanced, proactive, real-time configurable notifications, are accessible through the GUIs on the user terminals 110a-110e. The retrieval of the data occurs in real-time and can be displayed as a result of user input into an input-output (I/O) device (not pictured) internal or in communication with the user terminal 110a-110e, or can also be displayed automatically upon initialization of the software by the user terminal 110a-110e or another server within the technical environment. User terminals 110a-110e include, but are not limited to, desktops, mobile computers (such as laptops), smartphone, handheld electronic devices, and/or PDAs.

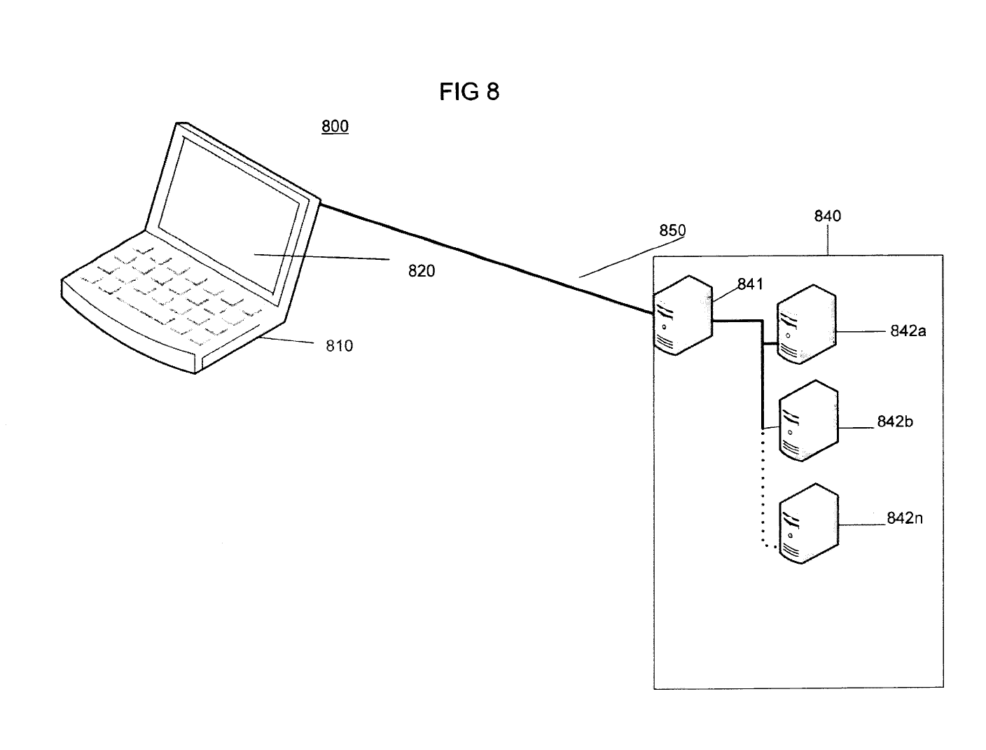

The user terminals 110a-110e connect to a server 120 over a network connection. The network connection between each user terminal 110a-110e and the server 120 includes, but is not limited to, a public network, a virtual private network (VPN), a local area network (LAN), a wide area network (WAN), wireless LAN, wireless WAN, wireless PAN and/or the Internet. Further embodiments, such as the embodiment of FIG. 8, which is a cloud architecture, utilize more than one server 120. The single server 120 architecture is displayed in FIG. 1 to illustrate aspects of an embodiment of the present invention. One of skill in the art will recognize that the storage and processing handled by the server 120 can be distributed over one or more additional computing resources.

The server 120 communicates with the user terminals 110a-110e to present data in a customized manner. The customizations of the views to various users will be discussed in more detail in later figures. Meanwhile, the server 120 contains an operational data store (ODS) 130, which houses data that is pulled from a variety of sources. The server 120 also contains a processor 140 that executes computer code that configures the data for presentation to end users of the system via the user terminals 110a-110e. Users of the system can utilize user terminals 110a-110e to configure thresholds (i.e. define parameters) within the system that will be related to the data in the ODS 130 to see if they are met. One of skill in the art will recognize that these predefined thresholds (parameters) can be defined by different users at different points of entry into the system. For example, parameters can also be defined at the server and included in code executed on the server 120.

The ODS 130 can utilize off-the-shelf relational database solutions to pull, process, store, and present the data. Storage and processing solutions include, but not limited to, Microsoft SQLServer, Oracle, and/or MySQL. Presentation solutions include but are not limited to, SharePoint, Drupal, ColdFusion, Oracle WebCenter Spaces, Websphere Suite, and/or Jive/Clearspace.

Computer code executed on the processor 140 of the server 120 collects, consolidates, and organizes data from multiple disparate sources and saves and organizes the data onto one or more memory resources (not pictured) internal and/or external, but accessible to the server 120. The ODS 130 on the server 120 includes modules for both processing and retaining data. Data managed by the ODS 130 includes both current and/or historical data. In some embodiments of the present invention, historical data that is deemed less relevant is off-loaded to an external storage device, e.g., a computer resource, (not pictured) in order to maximize the performance of the system. In another embodiment of the present invention, data that is deemed less relevant may be purged from the ODS 130, but can be retrieved if necessary by the server 120 from the original source and reintegrated into the ODS 130 as needed.

In an embodiment of the present invention, systems that are the sources of data sets integrated into the ODS 130, at the server 120 include, but are not limited to, the following systems: Statewide Data Warehouse, Student Information System, Special Education System, Intervention System (AIS/RTI), School Lunch System, Transportation System, Formative, Diagnostic & Summative Assessments, Teacher Observations, anecdotal and/or journal comments related to student progress, behavior and reflections, and/or student, parent and teacher performance goals. These enumerated data sources are discussed in greater detail below.

Among the possible sources for data sets, the Statewide Data Warehouse, houses information reported via The New York State Student Information Repository System (SIRS). This is a single source of standardized individual student records for analysis at the local, regional, and State levels to improve student performance and to meet State and federal reporting and accountability requirements. The information in this Warehouse comes from Local Education Agencies (LEAs), who are required to report certain data to the New York State Education Department (NYSED). LEAs include districts, charter schools, the New York State School for the Deaf, and the New York State School for the Blind. Additionally, certain State agencies (e.g., OCFS, DOC, OPWDD, OMH) and approved private schools that provide educational services also report data using the SIRS. Nonpublic schools who participate in State assessments in elementary/middle-level ELA, mathematics, science, or secondary-level Regents exams also report these data using the SIRS.

A Student Information System (SIS) is a software application for education establishments to manage student data. Also known as student information management system (SIMS), student records system (SRS), student management system (SMS), campus management system (CMS) or school management system (SMS). An SIS contains a variety of information about a student, including, but not limited to, demographic, enrollment, special program, attendance, grades, discipline and transcript information. In contrast to the Statewide Data Warehouse, which is a summative, historical database of past information about a student, an SIS contains more granular, current information.

A Special Education Management System (SpEd System), which is similar to an SIS, the SpEd System in tracking student information. However, the SpEd System tracks additional data sets for students with special needs. This includes special program information, Individual Education Plans, referrals, Medicaid claims and resource provider collaboration.

Academic Intervention Services (AIS) and Response to Intervention (RTI) are Intervention Systems. Academic Intervention Services, AIS, is a program of supplemental instruction beyond the general curriculum to help students at risk of not achieving New York State Learning Standards. These services are designed to improve academic performance and may include academic, guidance, counseling, attendance, and study skills. Response to Intervention, RTI, is a multi-tiered approach to the early identification and support of students with learning and behavior needs. The RTI process begins with high-quality instruction and universal screening of all children in the general education classroom. Struggling learners are provided with interventions at increasing levels of intensity to accelerate their rate of learning. These services may be provided by a variety of personnel, including general education teachers, special educators, and specialists. Progress is closely monitored to assess both the learning rate and level of performance of individual students. Educational decisions about the intensity and duration of interventions are based on individual student response to instruction. RTI is designed for use when making decisions in both general education and special education, creating a well-integrated system of instruction and intervention guided by child outcome data. These interventions systems provide a large amount of granular data due to the close tracking of the students who are participating.

School Lunch Systems, which track USDA requirements for school lunch programs, as well as information relative to family income (i.e., poverty status/free/reduced lunch information), may also be integrated into the present system and method.

Transportation Systems, which include, but are not limited to, bus routes, and student bussing schedule, also lend intelligence to embodiments of the present invention.

Various assessments serve as data sources in various embodiments of the present invention. Formative Assessments completed by staff members in an educational environment provide assessments of learning the student population and can assist in evaluating whether individual students are reaching benchmarks. Meanwhile, Diagnostic Assessments serve as benchmarks of a student's growth at key points through the academic year (i.e., Fall, Winter, Spring). Summative Assessments are assessments of learning, understood as a summary or culmination.

As well as formally reported data, such as the Statewide Data Warehouse, data that is less formulaic also lends intelligence to embodiments of the present invention. For example, some embodiments of the present invention utilize Teacher Observation Data which are data collected about a teacher as observed by an administrator or peer as a part of either an informal or formal observation process. This data can be collected as a part of the 60% of APPR HEDI Score. Additionally, some embodiments utilize anecdotal comments, which are journal entries relative to student learning/progress.

Finally, some embodiments of the present invention utilize one or more data sources containing Performance Goals. These are learning goals as set by any one and/or a combination of the following stakeholders: students, parents, teachers, administrators, SED. These Performance Goals contribute to the thresholding/benchmarking information that assists the invention is recognizing factors to predict and manage student outcomes, reduce the achievement gap between the highest and lowest performers, and assist the students within the educational environment in maximizing their academic success.

The data from the various sources/systems is pulled at a predetermined interval, for example, once a day, from the various sources and pooled onto the server 120. The processor 140 on the server 130 executes computer code that runs a predetermined number of procedures that clean, optimize, and/or format the data for use in data analyses. The structure and function of the ODS 130 is explained in more detail in FIG. 2.

The ODS 130 is a central repository for data originating from several systems, and operates like a data warehouse. The types of systems that supply this data were previously discussed. FIG. 2 is a flowchart 200 representing the structure and functionality of an embodiment of the ODS 230. The ODS 230 is comprised of a Reporting Server 232 and a database, termed a Super Database 234, as it contains a consolidation of data from a wide variety of sources, including those discussed in reference to FIG. 1. In order to be delivered to users of the system, data are processed by the Reporting Server 232, which is configured and optimized to run reports. In this embodiment, data are processed by the Reporting Server 232 after taking one of two routes into the ODS 230. The route taken by the data into the Reporting Server 232 in the ODS 230 is determined based on whether the data are standardized under a Unified Data Model at the time that they are imported into the ODS 230. In this model, the data are stored in a single, standard format, even if the source data systems have dramatically different ways of storing the data. If the data are standardized and formatted, they can be accessed, excerpted, and/or configured immediately by the Reporting Server 232. If the data are not in the Unified Data Model, they are organized and mined before they are utilized in the Reporting Server 232.

Data from the various sources 238 discussed in reference to FIG. 1 are standardized before being processed by the Reporting Server 232. Before population in the Super Database 234, the data are analyzed for patterns that will allow the varied data to be simplified into a Unified Data Model. In the embodiment of FIG. 2, data that are pulled from various source/systems 238 at predetermined intervals are cleaned, optimized, formatted and housed (upon completion of these processes) in the Super Database 234, from where the now-standardized data can be pulled into reports and/or alerts by the Reporting Server 232. The breadth of the data in the Super Database 234 varies in accordance with the type of information needed to trigger the user-determined thresholds that relate to the student goals. In an embodiment of the present invention, data in the Super Database 2354 encompasses multiple systems and school districts. In some embodiments of the present invention, the Reporting Server 232 resides on a different physical machine than the Super Database 234.

The second route to the Reporting Server 232 is from a Data Warehouse 236. As aforementioned, Statewide Data Warehouse, termed The Data Warehouse 236 in FIG. 2, is a consolidated data source that is maintained on a state level. The Data Warehouse 236 is a collection of already-standardized summary level data regarding students in a given state.

The Data Warehouse 236 contains historical information regarding a student at a very high level. For example, the Data Warehouse in an embodiment of the present invention, contains data indicating that a given student was absent 3 times during a given school year. The Data Warehouse 232 will not contain a current data set regarding the most recent week of school and it also will not contain information regarding the reasons for the absences. This information, the current data set and the reasons for absences, can be supplemented from the non-standard data sources 238. By supplementing the summary from the Data Warehouse 236 with information from a data source 238, the Reporting Server 234 can deliver reports regarding the exact dates, reasons, and excused/unexcused status for all the absences of a student in that given period. Thus, the varied data sources 238 provide a level of granularity that is not available by utilizing only the Data Warehouse 236.

The Unified Data Model assists in creating and conveying relationships between data from multiple sources. In an embodiment of the present invention, the ODS 230 operates on the concept of a relational database. In the ODS 230, there are a number of tables, each concerning a different set of information. These information sets are related to each other through common fields. For example, in a “Student” table, a Student record will likely contain the name of the school that the student is enrolled in. In a “School” table, a school record will contain what the name of the school is. Using the School Name as a common field, a relationship is formed.

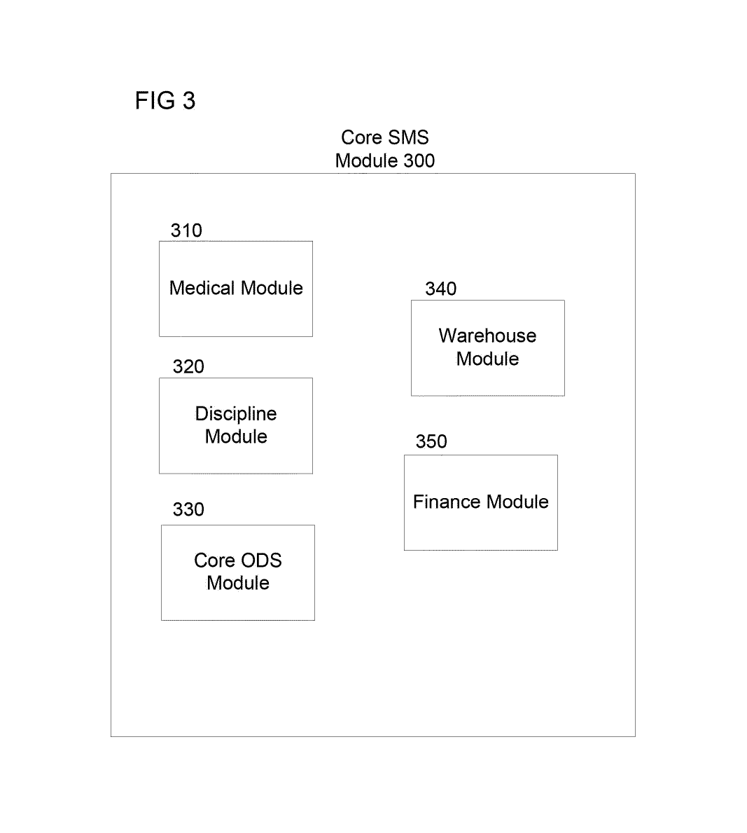

The data in the ODS 230 is divided into a number of modules, each comprised of one or more data tables. In an embodiment of the present invention, the Student Management System (SMS) Core Module houses the majority of the data available to the Reporting Server 234 and is comprised of at least one sub-module. FIG. 3 is a diagram the SMS Core Module 300 and displays the sub-modules that comprise this module in an embodiment of the present invention. Discussed below are the Medical Module 310, the Discipline Module 320, the Core ODS Module 330, the Warehouse Module 340, and Finance Module 350.

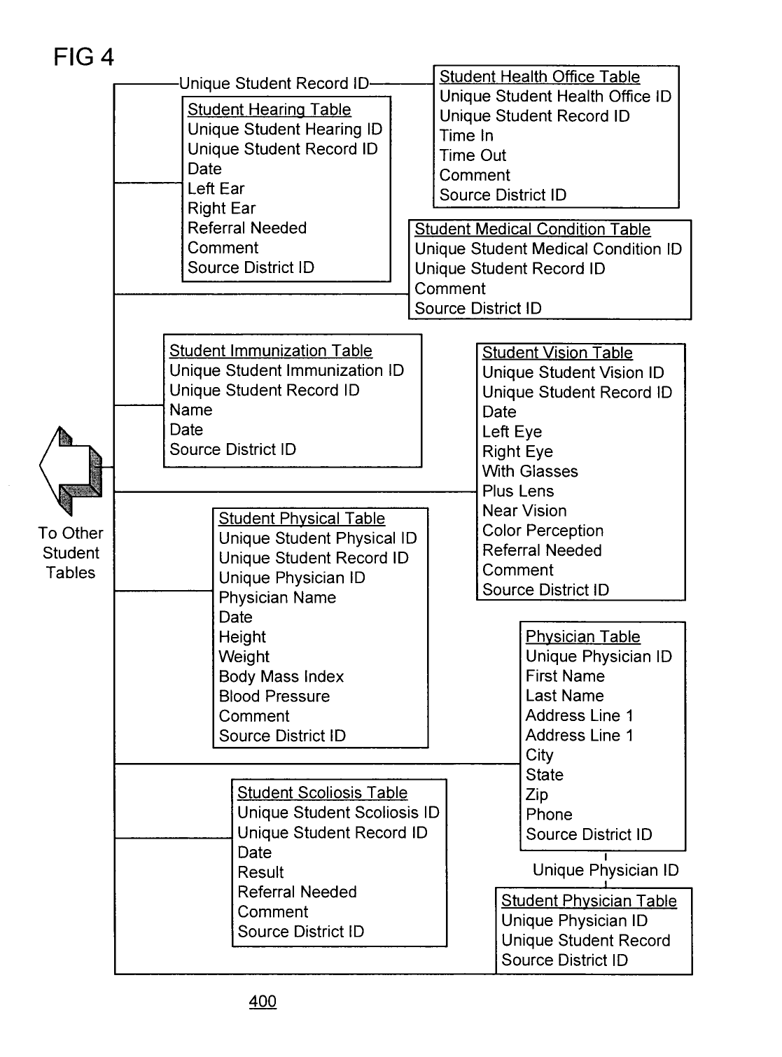

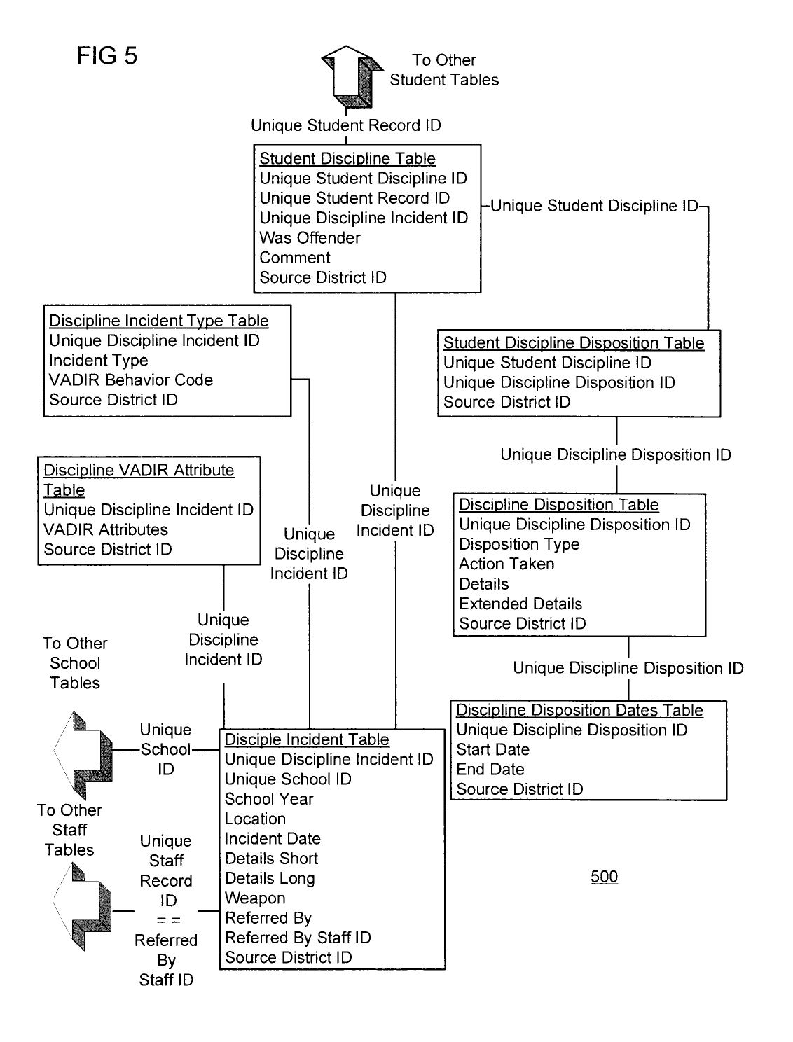

Referring to FIG. 3, the Medical Module 310 is a sub-module and comprises at least one table pertaining to student medical records, nurse's office visits, etc. An embodiment of this module is FIG. 4. The Medical Module 310 contains student health information, including, but not limited to, student allergies, medical alerts, visits to the nurse and health history information, as collected by the school district.

The Discipline Module 320 is a sub-module that comprises at least one table pertaining to discipline incidents, dispositions, Violent and Disruptive Incident Reporting (VADIR), etc. A data model of an embodiment of the Discipline Module 320 is FIG. 5. The Discipline Module 320 contains student discipline information, including, but not limited to, violations and infractions of the student code of conduct, staff discipline referrals and incidents tracked for the purposes of state reporting (DASA and VADIR).

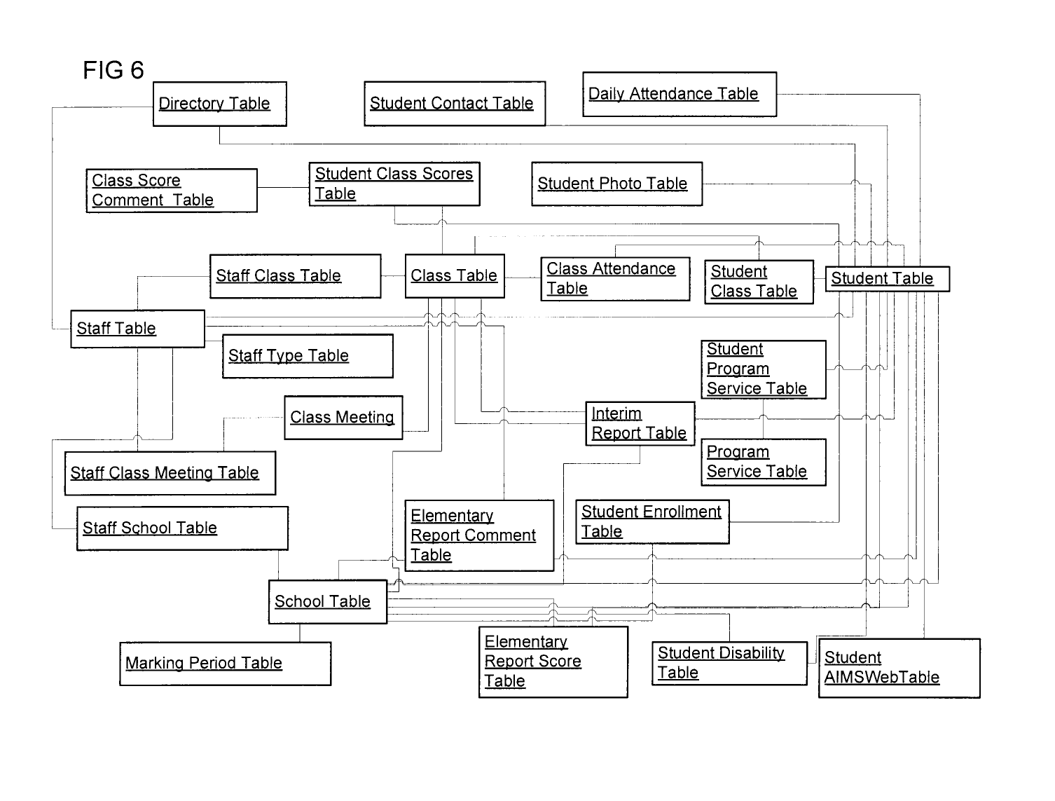

The Core ODS Module 330 is the principal repository of the SMS sub-modules. A data diagram of the Core ODS Module 330 is FIG. 6. Each of the submodules within the SMS system are housed in the SMS Core Module 330. This is where each of the data sets from various systems become normalized, enabling for cross-district, cross region and cross state analysis. The Core ODS Module 330 also contains current and previous year student information, including, but not limited to, scheduled courses, interim and marking period comments and grades, special program participation and other student demographic and learning information as houses within the student management system. The data housed within this module is more granular that the summary type of information that is housed within the Warehouse Module 340.

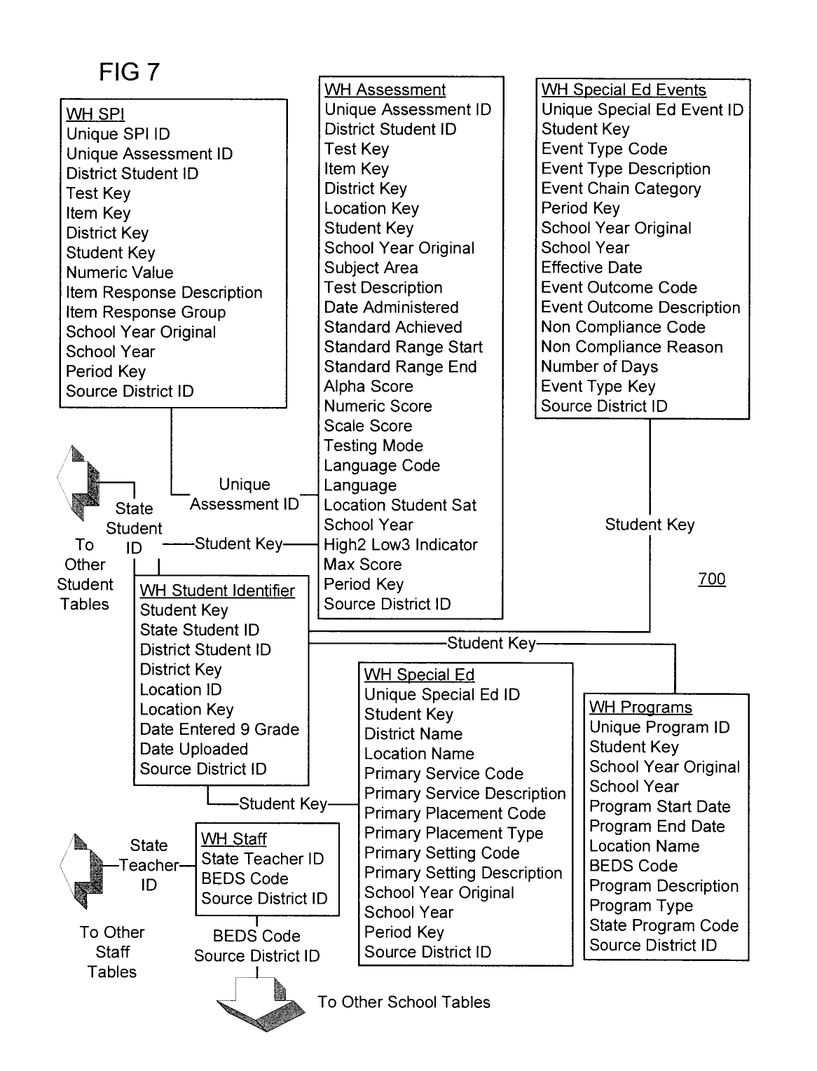

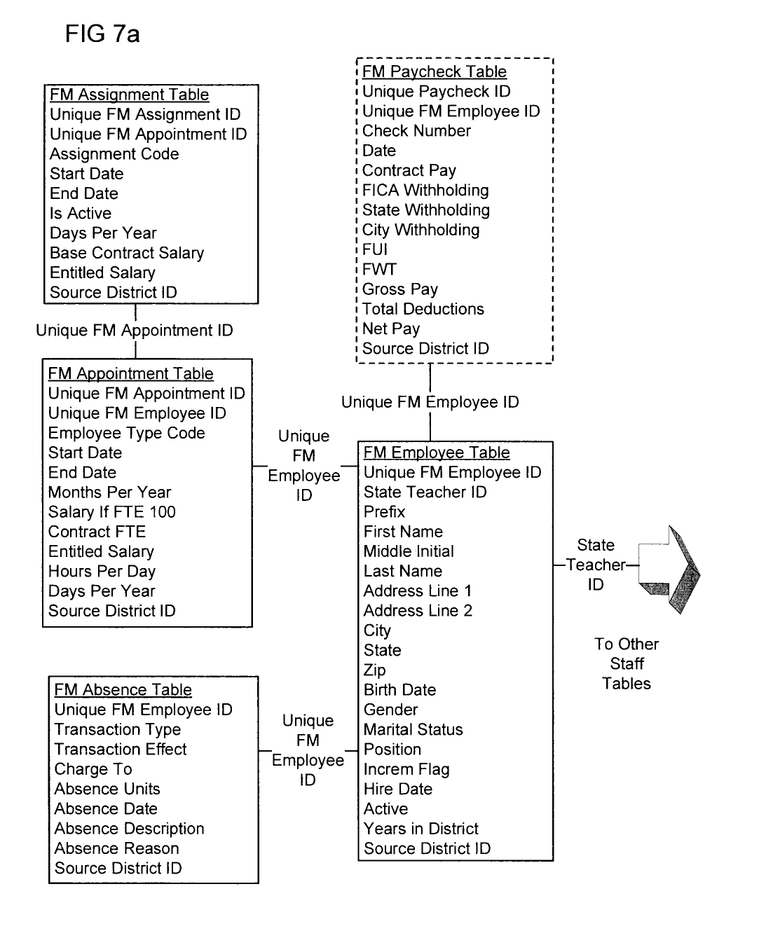

A Warehouse Module 340 is utilized the store information from the State Level Data Warehouse discussed earlier. A data model of an embodiment of the Warehouse Module 340 is displayed in FIG. 7. Not that the data stored in the Warehouse Module 340 is very high level summary information. Granular details supplementing this information is located across different modules in the ODS. The warehouse module contains information that is housed in the NYS Data Warehouse and that has been reported for State and Federal Accountability purposes (NCLB & RttT). The data contained in this module is more summative in nature than the granular data found within the SMS modules.

Referring to FIG. 3, the Finance Module 350 contains data from Finance Systems that are often local to the school and/or district of the end users. The Finance Module 350 contains staff information including, but not limited to, human resource related information (date of hire, educational background, continuing education, state-wide TEACH ID), payroll information, staff attendance and program budget and spending. A data model of an embodiment of the Finance Module 350 is displayed in FIG. 7a.

Returning to FIG. 2, the Reporting Server 232 maintains the security of the system as well as the integrity of the data in the ODS 230. Users of the system include, but are not limited to, administrators, teachers, parents, students, and assorted staff within an educational environment, such as a school and/or district. Thus, information that is heavily utilized by certain users may be inappropriate for other users. The Reporting Server 232 is a component in filtering data so that data is supplied in accordance with the security level of the user.

The Reporting Server 232 executes Report Procedures, comprised on computer code that is executable by a processor. The Report Procedures comprise custom queries, including SQL queries, that are run against data in the ODS 230, and return results to an application server (not pictured) running on the server 120 in FIG. 1, and the user terminals 110a-110e as well. The Report Procedures have built in security, ensuring that users with insufficient privileges are not presented with data that they aren't allowed to see. For example: students cannot view other students' report cards, but teachers can see all report cards belonging to students that they teach.

Users can potentially have one or more staff member records in the SMS and, consequently, one or more records in the ODS. These records are tied to different schools and students through intermediary tables. In an embodiment of the present invention, Staff Members are categorized as Administration or Teaching staff. Administrative users have access to all data that is tied to their schools, or any students that they teach in the current academic year. Teaching staff have access to select data sets, concerning students that they teach in the current academic year.

Rather than utilizing a server 120 to connect to, house, process, and supply data to user terminal 110a-110e, an embodiment of the present invention utilizes a cloud computing model. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. It is understood by one of ordinary skill in the art that any external data processing and storage system with these characteristics would also be included in this disclosure.

One characteristic of the cloud computing model is that a consumer can unilaterally provision computing capabilities, such as CPU power and storage capacity on the network, as needed automatically without requiring human interaction with the service's provider.

The resources of the cloud are available over the network and can be utilized by consumers using a custom thin client, a software application that uses the client-server model where the server performs all the processing, or a standard web browser, running on a user terminal, including but not limited to smart phones, touchpad computers, tablet computers, desktop, and mobile computers, such as laptops.

By taking advantage of the computing power of the cloud system, software providers have the capability to distribute software as a service (SaaS), meaning that a consumer uses a provider's applications running on a cloud's infrastructure. The applications are accessible to the consumer from various user terminals through a thin client interface such as a web browser (e.g., web-based email).

By deploying software into a cloud, the software provider accesses processing, storage, networks, and other fundamental computing resources. The provider does not manage or control the underlying cloud infrastructure but has control over operating systems, storage, deployed applications, and possibly limited control of select networking components (e.g., host firewalls).

The cloud computing model allows services to be delivered through shared data centers that can appear as a single point of entry, or a communications gateway, for a terminal accessing the cloud. For example, a user accessing an application as a service or a platform as a service may use a web browser to connect to a URL. At that URL, the user gains access to the cloud. While accessing the cloud through the web browser, the user will not be aware of the computers or networks that are serving the application and/or platform that the user is accessing. Whether there is a single web server interacting with the thin client or a farm of servers will not be known to the user. The back end computer resources are not important to the user, as the owner of the cloud works to provide the user with the cloud services seamlessly.

Because the user relies upon the computing power of the cloud and not upon that of the terminal he or she is using to access the cloud, this model is device independence. By utilizing the cloud to provide applications and platforms as a service, the specifications of the device or terminal used to connect to the cloud are non-limiting.

Referring to FIG. 8, the technical architecture 800 of an embodiment of the claimed system used to practice the method of the invention includes a user terminal 810 running a thin client 820, such as a web browser, which serves as the graphical user interface (GUI), also called the front end. The user terminal 810, connects to a data processing and storage system 840, such as a cloud, over a network 850.

The data processing and storage system 840 in this embodiment includes but is not limited to, a server-side proxy component 841 at least two back-end computers 842a, 842b, 842n, which contain the computing and storage resources of the data processing and storage system 840. In FIG. 8, the resources of the data processing and storage system 840 are located in the same physical facility. However, in additional embodiments of the present invention, the resources of the data processing and storage system 840 are spread out over at least two different physical locations.

The network 850 connecting the user terminal 810 to the data processing and storage system 840 includes but is not limited to a public network, a virtual private network (VPN), a local area network (LAN), a wide area network (WAN), wireless LAN, wireless WAN, wireless PAN and/or the Internet.

Installed on the application server resources 860 of the data processing and storage system 840, is back end software that performs operations that require processing utilizing processor resources in the data processing and storage system. Data processed when the software is executed on the processor(s) is/are saved in the storage resources of the data processing and storage system and/or can be further utilized by the application server resources of the data processing and storage system 840 to interact with servers internal and external to the data processing and storage system 840 (not pictured). For example, a server running a billing system may be internal or external to the data processing and storage system 840. As a result of the data processing in the data processing and storage system 840, data may be returned to the user terminal 810 and can render in the thin client 820.

Thus, utilizing the architecture of FIG. 1, a server 120 transparently performs the processing and houses the ODS 130, Utilizing the architecture of FIG. 8, the ODS 130 and associated processing is farmed to various resources within a cloud, i.e., a data storage and processing system 840.

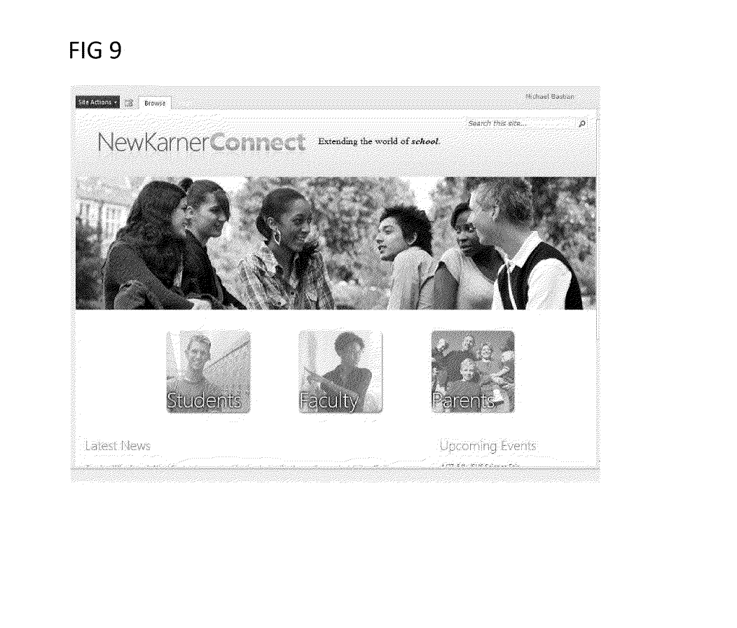

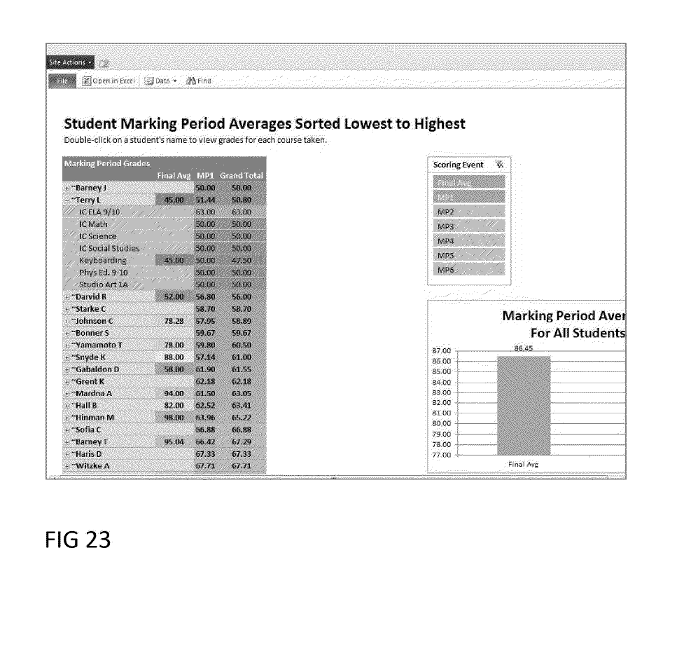

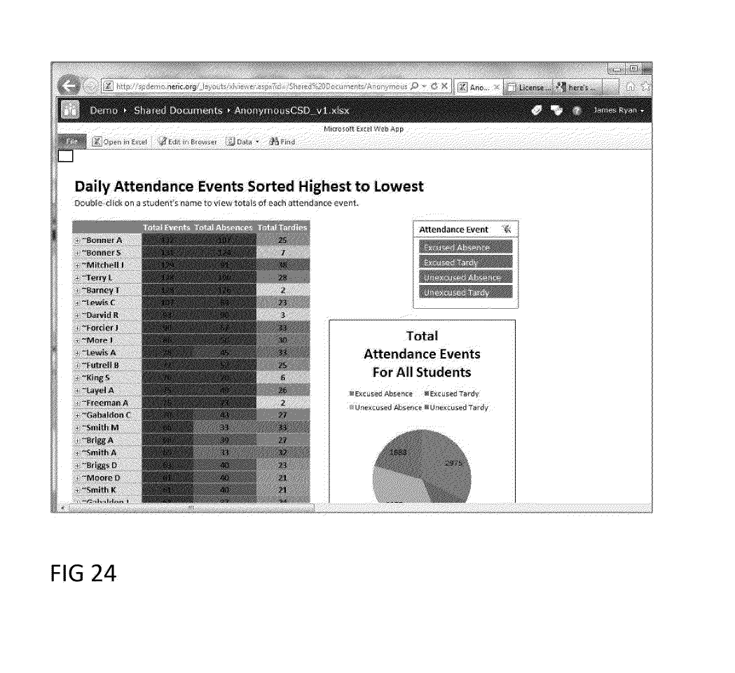

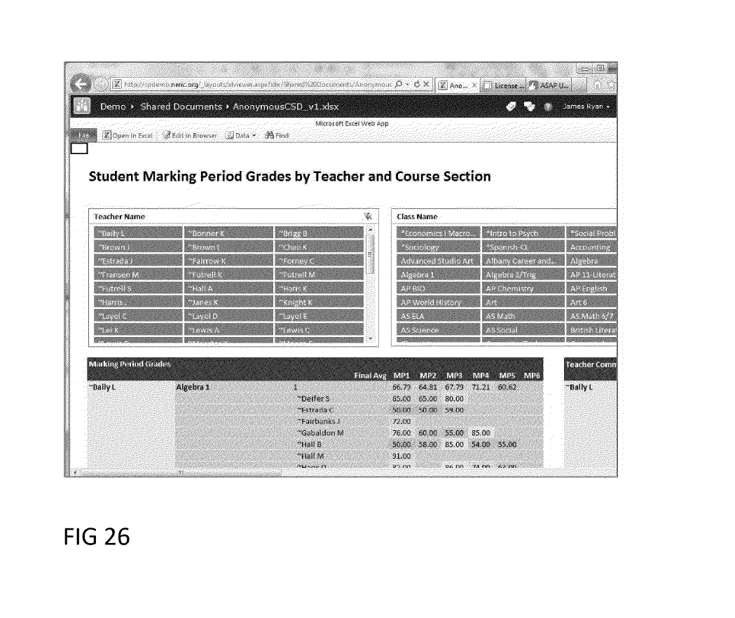

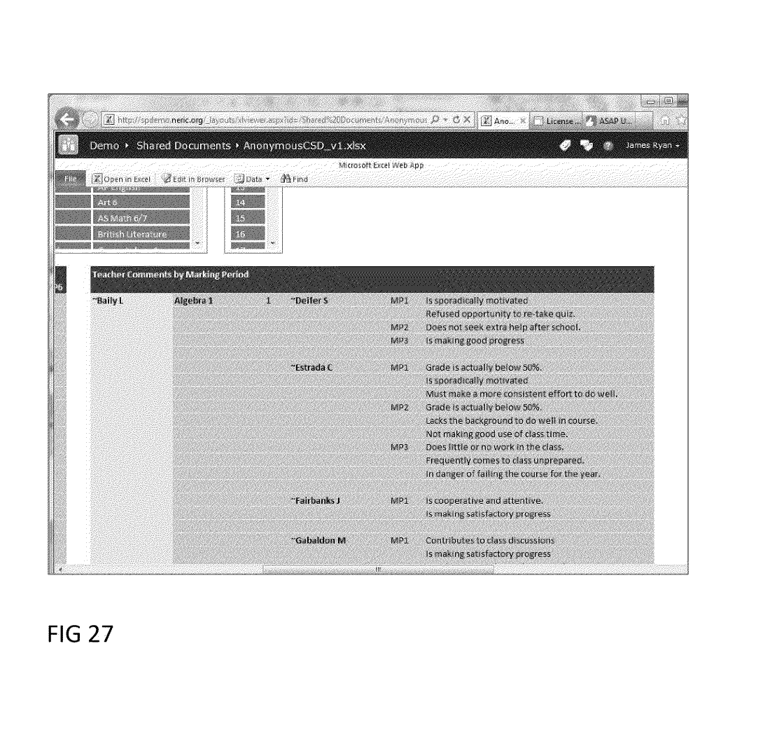

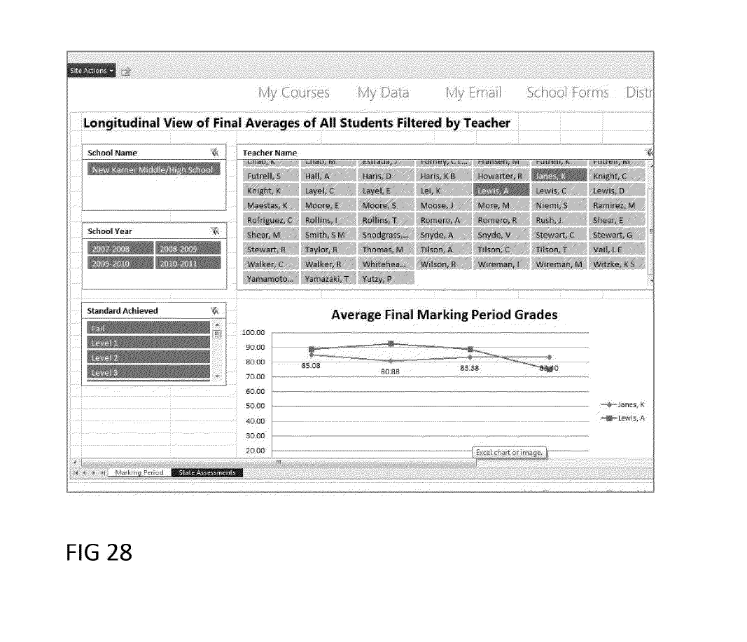

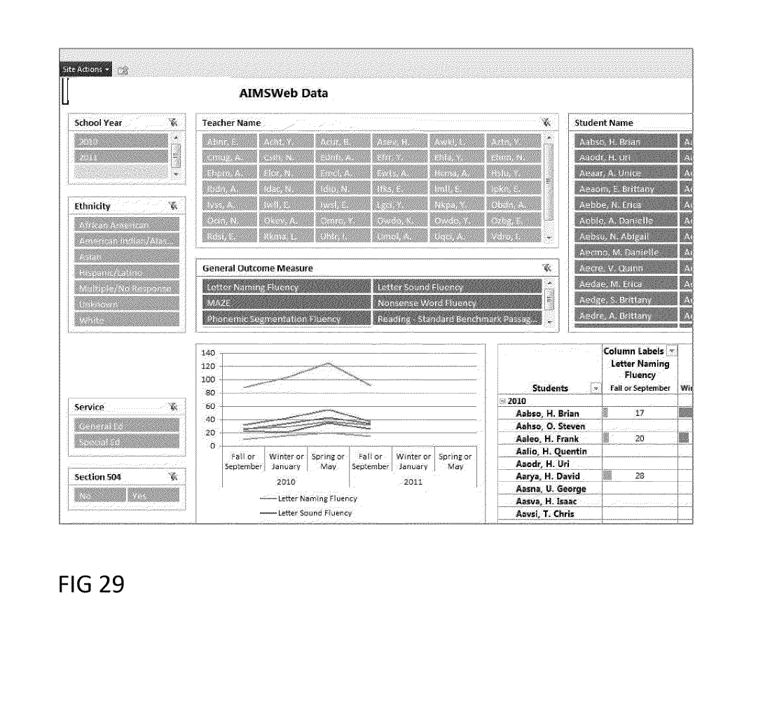

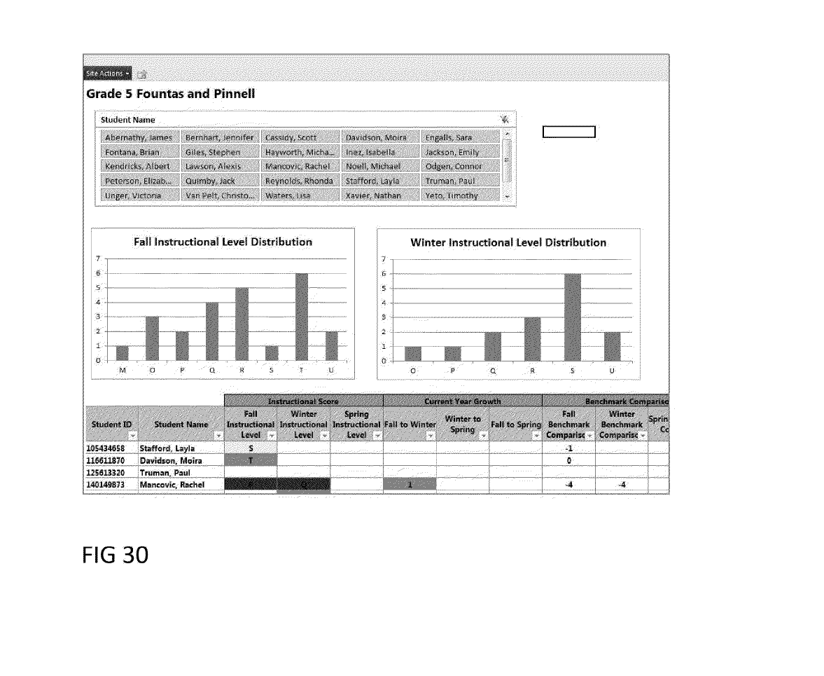

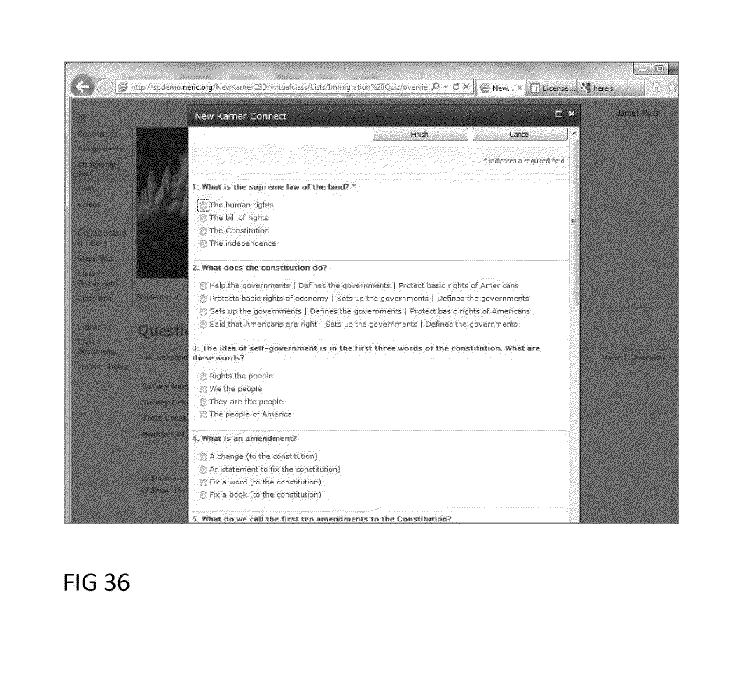

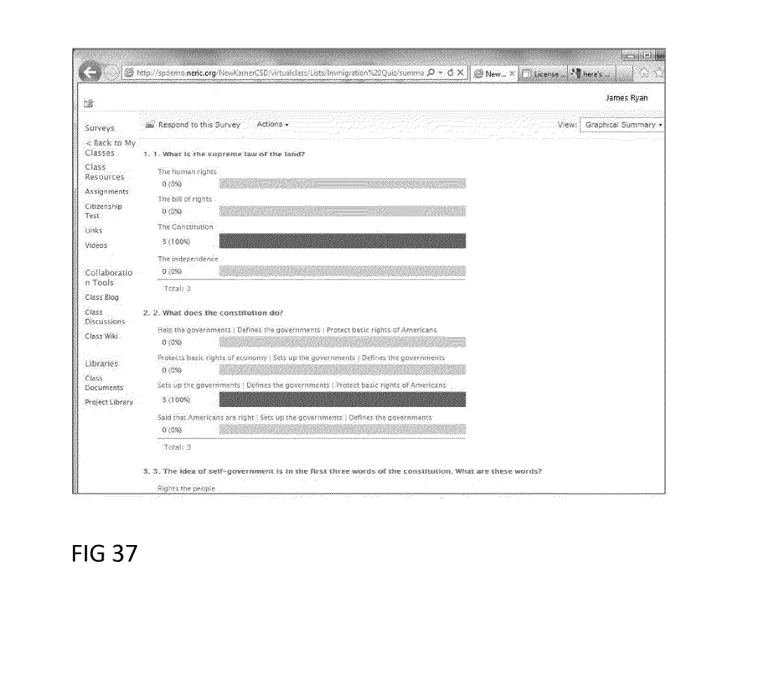

Returning to FIG. 1, whether the processing in handled by a cloud or one or more servers, the data, the reports, alerts, bulletins, and general announcements, are displayed in customized graphical user interfaces (GUIs) on the various user terminals 110a-110e. The GUI also presents the user with end user tools, including but not limited to, automated data dashboards, reporting and custom querying tools, and/pr graphically enhanced, proactive, real-time configurable notifications are accessible through the GUIs on the user terminals 110a-110e. FIGS. 9-39 are exemplary screens in a GUI through which a user navigates to access and utilize data supplied by the system. One of skill in the art will recognize that the data display can take different forms once captured in the ODS 130 and formatted by the Reporting Server 232. The data is formatted and presented to users in various arrangements and configurations in order to render the data most actionable by the user.

FIGS. 9-41 display examples of how data that is captured in the ODS 130 and formatted by the Reporting Server 232 is displayed to a user of an embodiment of the present invention through a GUI. FIGS. 9-41 are examples and one of skill in the art will recognize the data, once assembled in the ODS 130 and served by the Reporting Server 232 is highly configurable in order to accommodate a wide variety of users who are accessing the data through a wide variety of devices.

Customization occurs on a user basis, through security, as well as on a population basis. FIG. 9 is a welcome screen that in an embodiment of the present invention, can be customized for each district with logos, colors, photos, etc. and serves as the entry point to for the GUI via the user terminals 110a-110e.

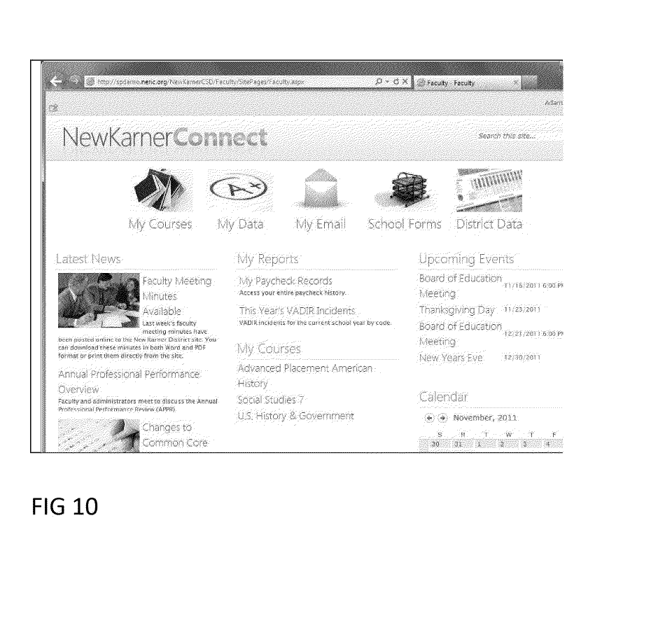

Referring to FIG. 10, an embodiment of the present invention displays a Main Faculty Page that provides access to Latest Building & District News, teacher-specific dashboards and reports, courses, and any other resource as determined by the district.

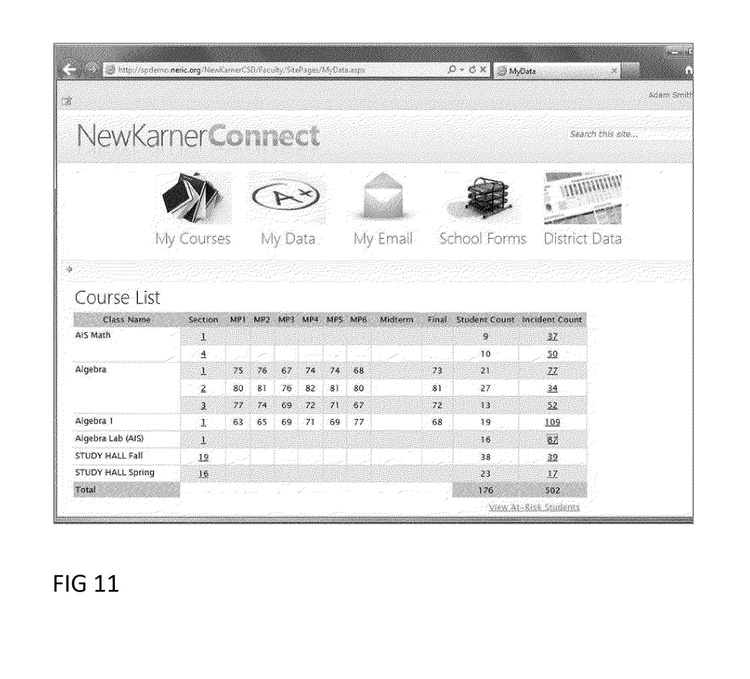

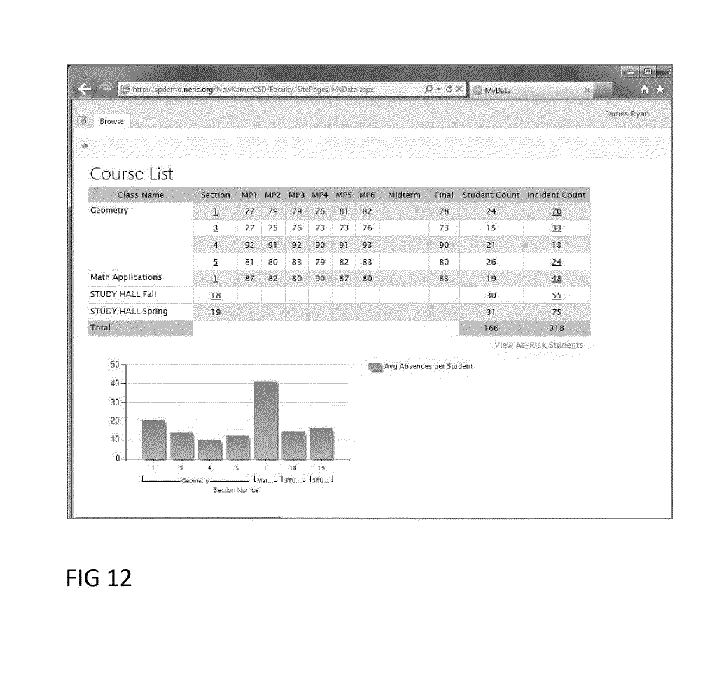

In an embodiment of the present invention, FIGS. 11-12 are screens that provide teachers with access to class averages for all sections in which they are the teacher of record, in an embodiment of the present invention. The Dashboard provides the teacher with a bar graph of total absences by section/period.

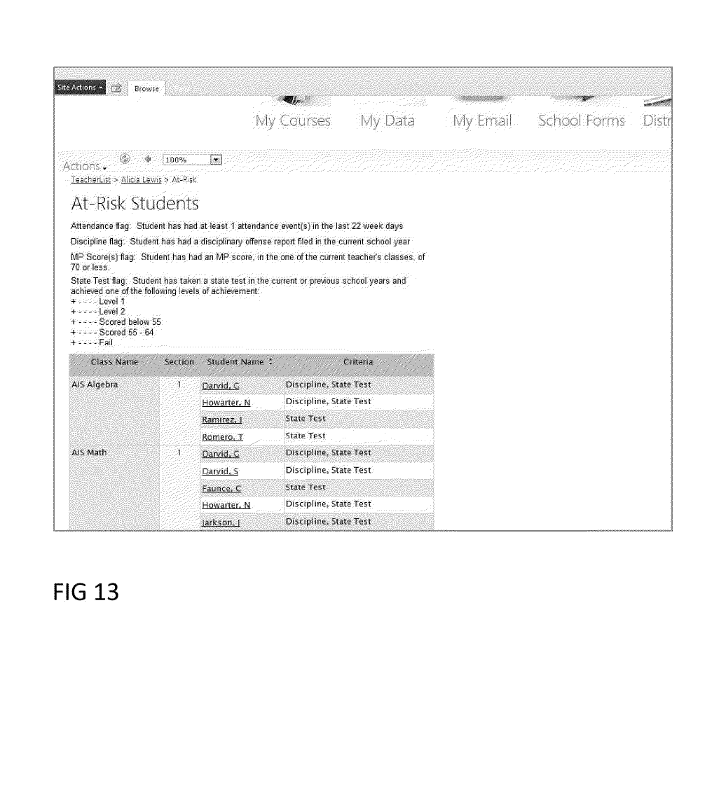

In an embodiment of the present invention, FIG. 13 is an “At-risk page,” which is a dynamic list of students that have met thresholds as determined by the district. An advantage of the present invention is its ability to alert users when thresholds are exceeded and to recommend action. Tracking quantifiable and customizable “at risk” criteria provides users of the system and method with this intelligence. For example, alerts can be provided for students in a class, grade, building, district, etc. (based on user permission), that have a given number of attendance events in a predetermined number of instructional days, and/or have a defined number of discipline infractions within the current school year, and/or have not met the state performance index on a given number of state exams (e.g., grades 3-8 or Regents exams). These criteria are configurable so that at risk students can be defined based on various factors which can be tracked through the ODS 130. For example, in an embodiment of the given invention, a given student appears on an “At-risk page” when s/he has at least one attendance event in the last twenty-two instructional days, one discipline infraction within the current school year, and has not met the performance index on a state exam. By flagging students as “at risk,” this embodiment of the present invention assists users in predicting and managing student outcomes, reducing the achievement gap between the highest and lowest performers, and assisting the students within the educational environment in maximizing their academic success.

Dynamic listings of students can be created on positive criteria as well as negative criteria. One of skill in the art will recognize that the system can be configured to recognize a factor or combination of diverse factors (supplied by the disparate data sources) and trigger an alert. Alerts can be configured to assist users in recognizing academic achievement as well as difficulties. The consolidation and standardization of the data in the ODS 130 enables any combination of factors to serve as a trigger within the system. Additionally, because the data is readily available within the system, users of the system need not input any information in order to have sufficient data to trigger alerts, such as the ‘At Risk List.”

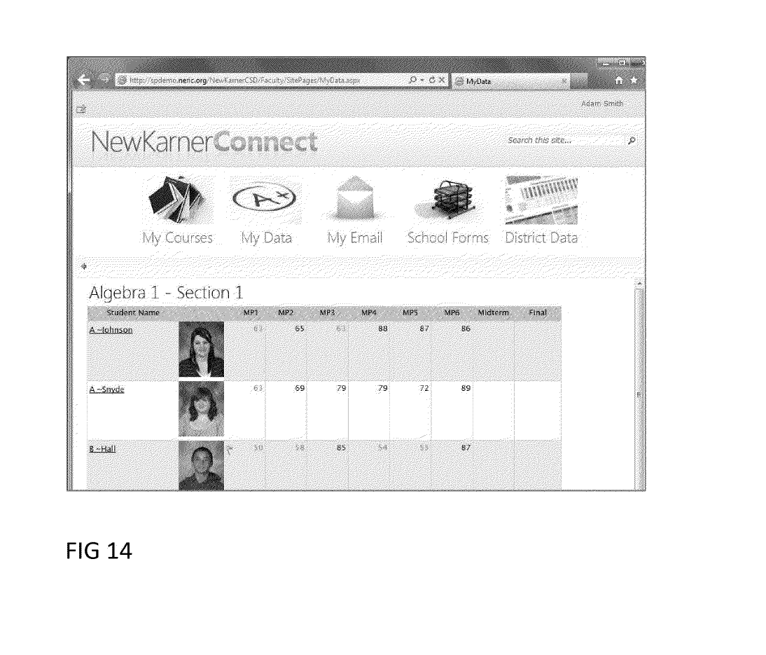

FIG. 14 is an exemplary teacher's view of an individual class section. The interface provides marking period, mid-term and final averages, student photos, and the ability to drill-down further into an individual student profile. While summary information in this screen may be pulled from the Data Warehouse Module, the granular information available when drilling down is available in other modules and originated from varied data sources. The consolidation of this diverse information into a snapshot provides users, who are teachers, with a fast, yet complete, overall view of the achievement of a given student.

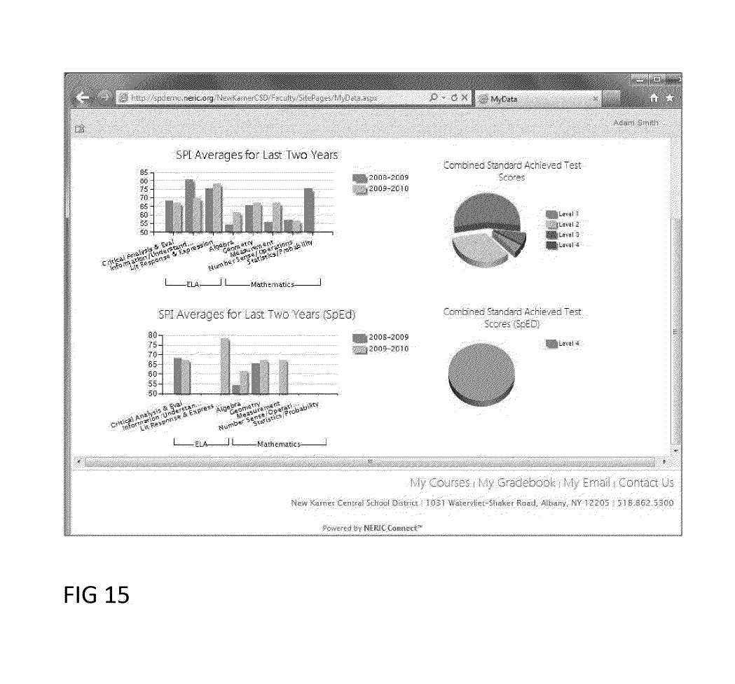

FIG. 15 is an exemplary display of combined information that lends intelligence to individual student results and allows the user to place the information in context. The first bar graph in FIG. 15 (available at the bottom of the class section screen) illustrates the average class performance on state exams over a predefined number of years (in this example, two years), broken down by student performance indexes as provided by, in this embodiment, New York State. The Second bar graph displays the same information, but further breaks down the population to those students classified and receiving special education services. Meanwhile, the first pie chart in FIG. 15 displays average/combined standards achieved for all students in the class for the previous two years. The second pie chart displays the same information, but only for the special education sub-group.

FIG. 15 provides an example of how the same results can be configured differently and how different images and/or text is helpful to a user dependent upon how that user intends to utilize the data.

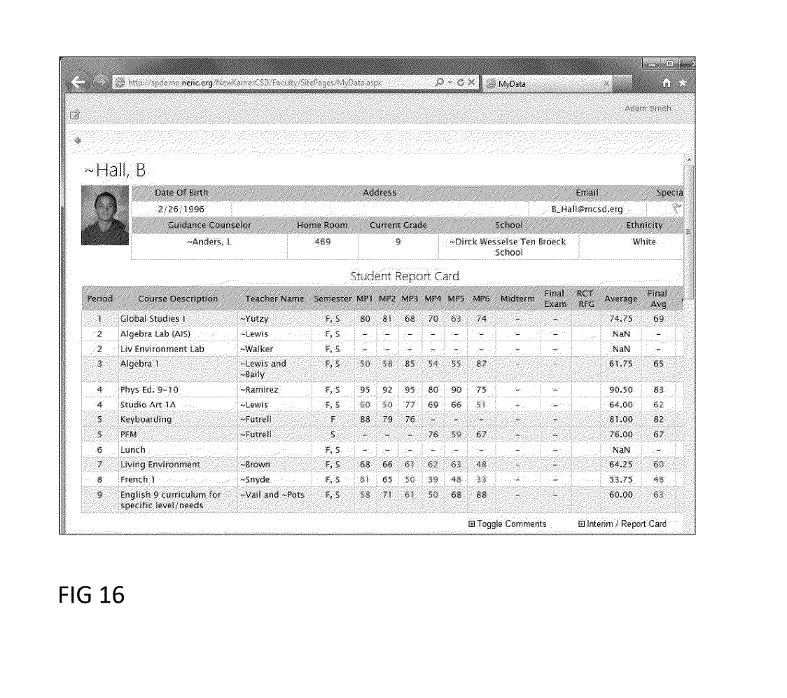

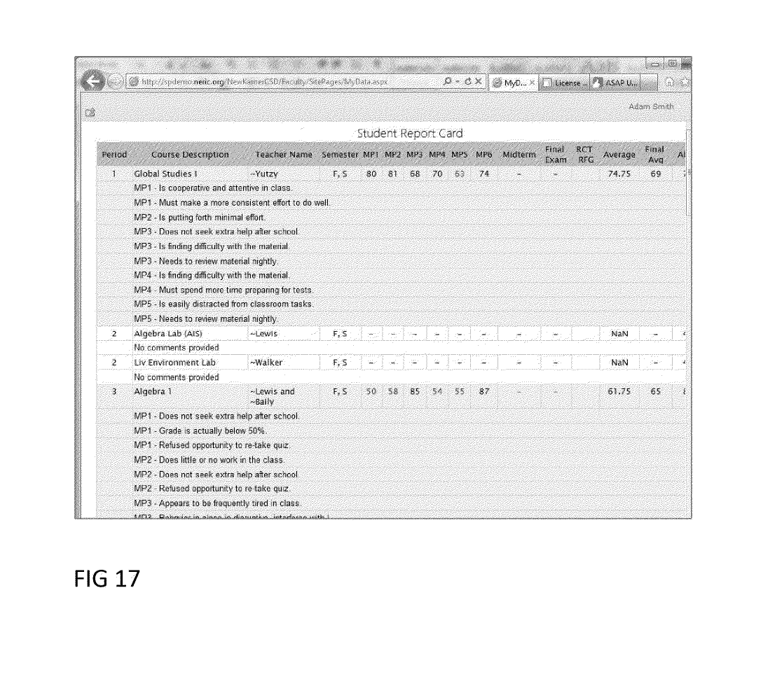

Referring to FIG. 16, by drilling down in a class section list, a teacher can view and absorb the complete student profile, the current and historical information about that student, as well as conditionally formatted data. Referring to FIG. 17, in an embodiment of the present invention, from the student profile screen, the user has the ability to toggle a year-long view of progress report and report card comments.

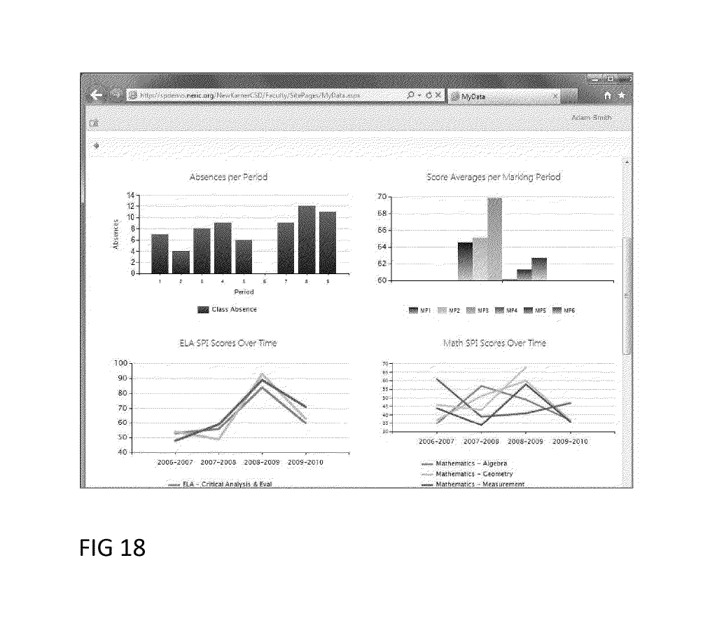

FIG. 18 displays options further down the student profile screen, in an embodiment. In FIG. 18, there are four dashboards specific to that individual student: Per period absence, Per Class Averages, English Language Arts and Math SPI Scores over time. This combination of data contributes to a full view of that student's achievement over the given period of time.

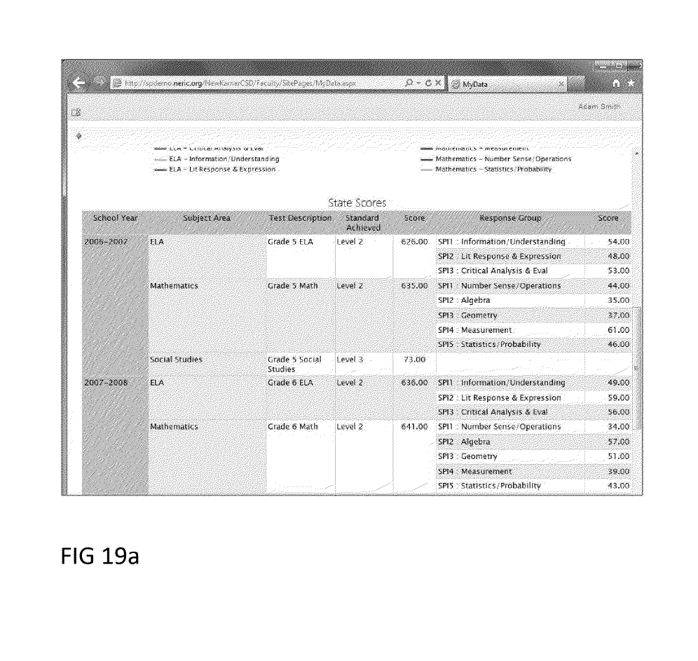

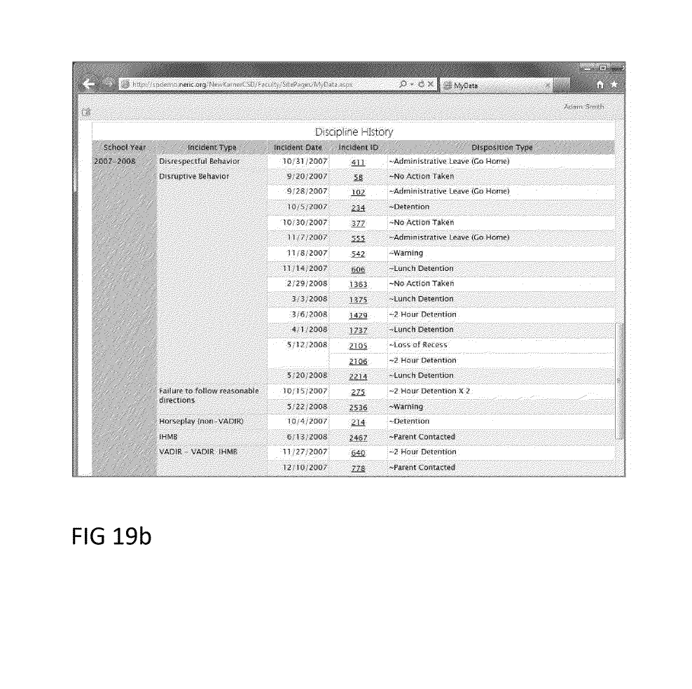

Referring to FIGS. 19a and 19b, at the bottom section of the student profile screen, there is a breakout of state tests scores (e.g., 3-8 and Regents Exams), diagnostic assessments, as well as discipline information. This is illustrated in FIGS. 19a and 19b.

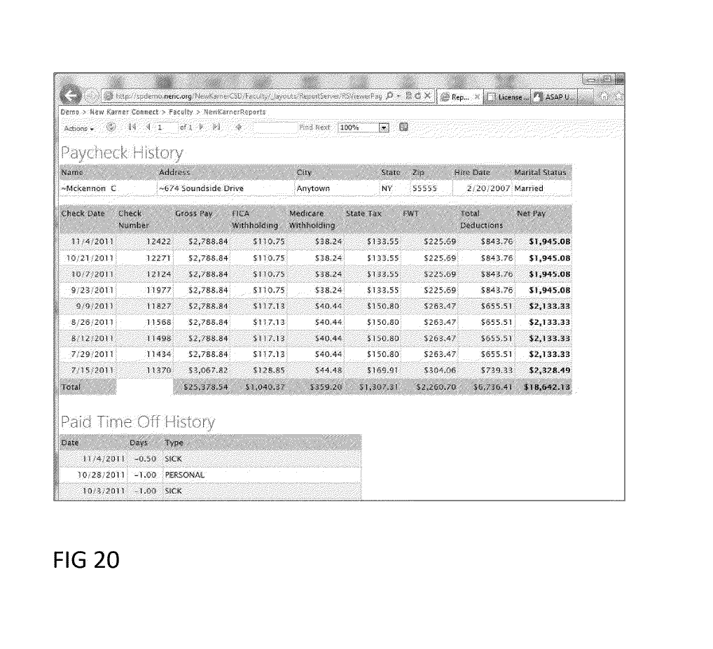

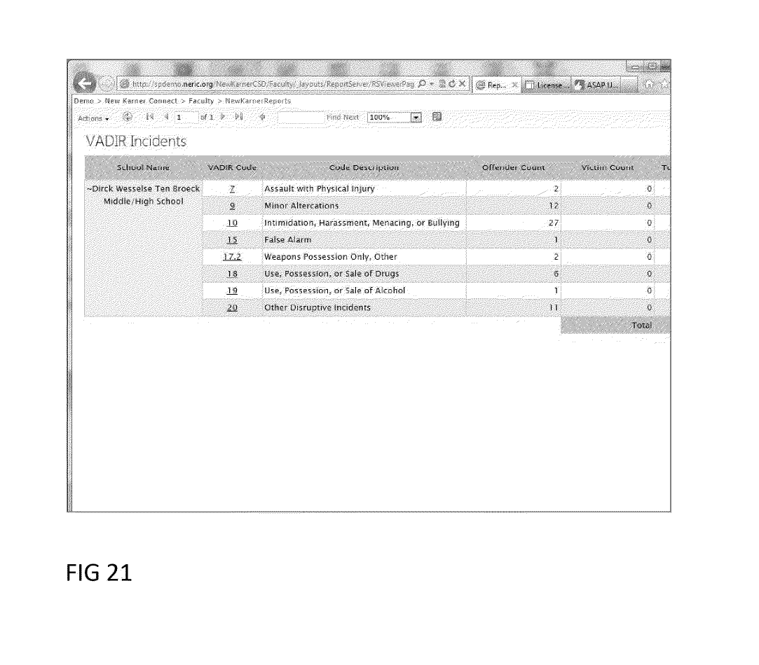

Due to the diverse capabilities of the system, information targeted at staff members is also retained and presented in a GUI. FIGS. 20 and 21 are examples of staff-specific reports available from the main faculty screen in an embodiment of the present invention. FIG. 20 is a history of pay and time-off, while FIG. 21 is a summary of incidents that have been reported and qualified as Violent and Disruptive.

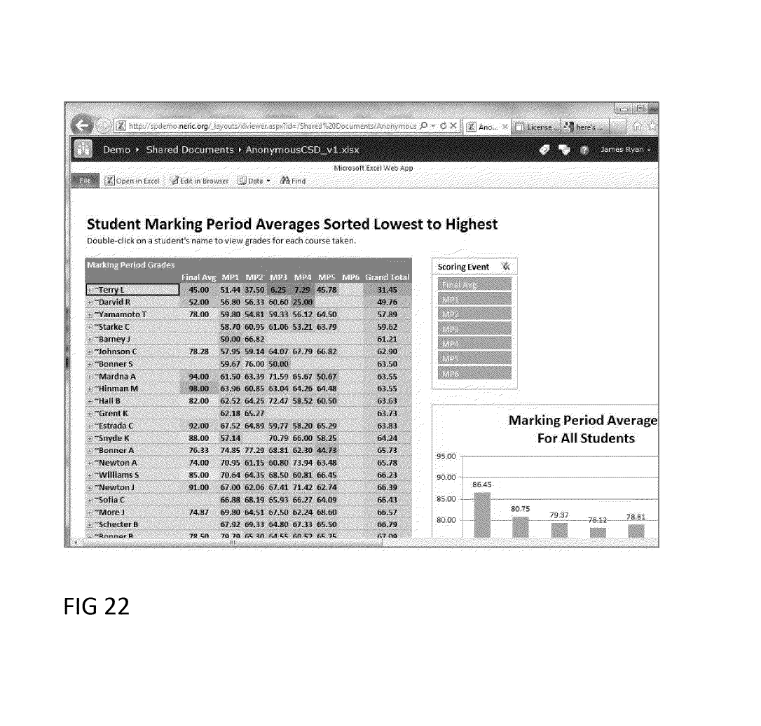

An embodiment of the present inventions allows ease in the comparison of multiple data sets, given that both current and historical data can be available from the data sources. FIGS. 22, 23 and 24 display examples of filterable reports available to administrators that allow the comparison of multiple data sets. For example, a user can compare the grades of a group of students in a given marking period to final grades across an entire district.

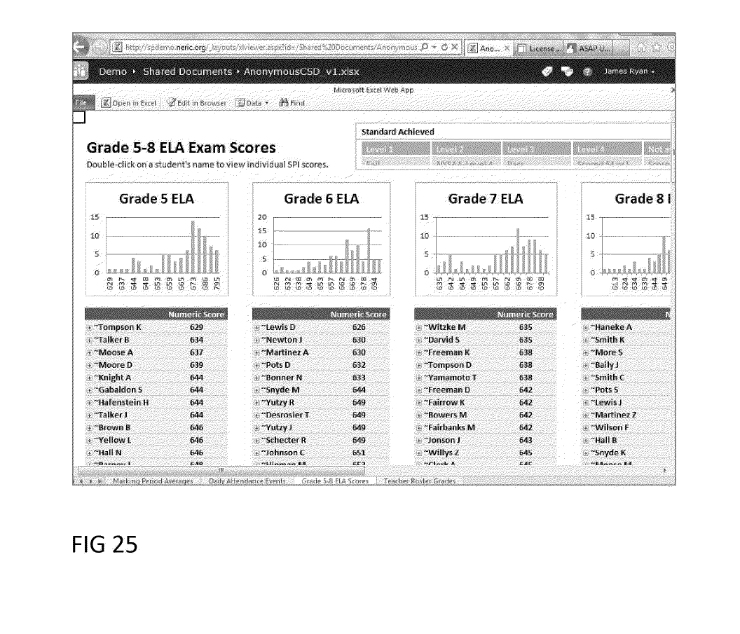

Utilizing summary level data from the Warehouse Module 340 in combination with other granular data sources, as discussed in reference to FIG. 3, allows users of the present system to pivot off multiple data sets. Referring FIGS. 25-30, the data in each of these reports has been aggregated from multiple sources across the district and state data warehouse.

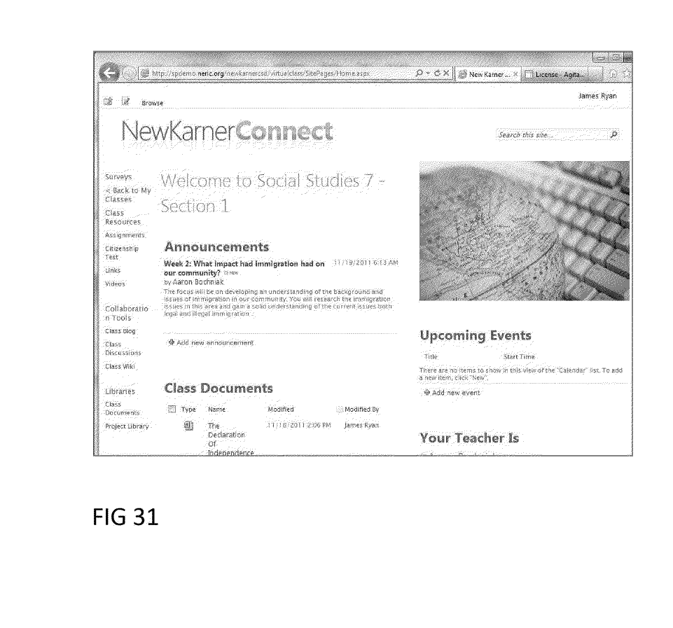

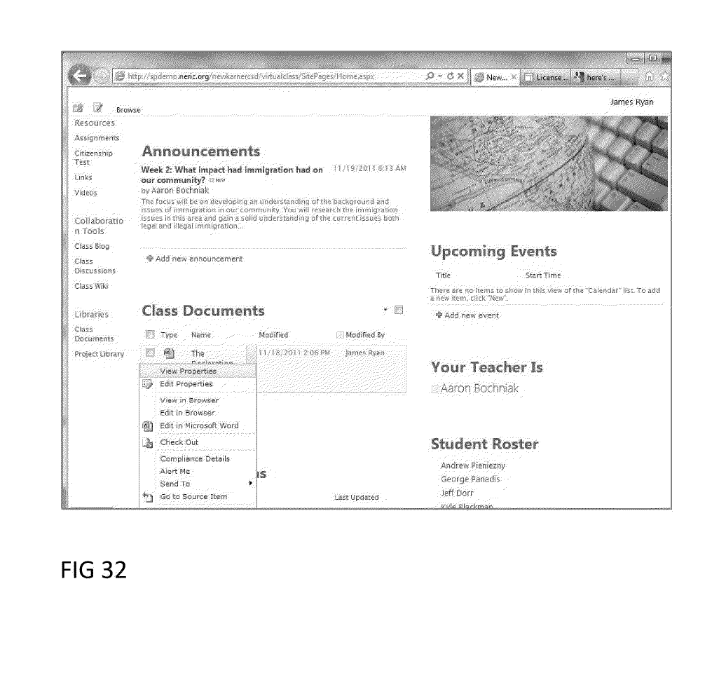

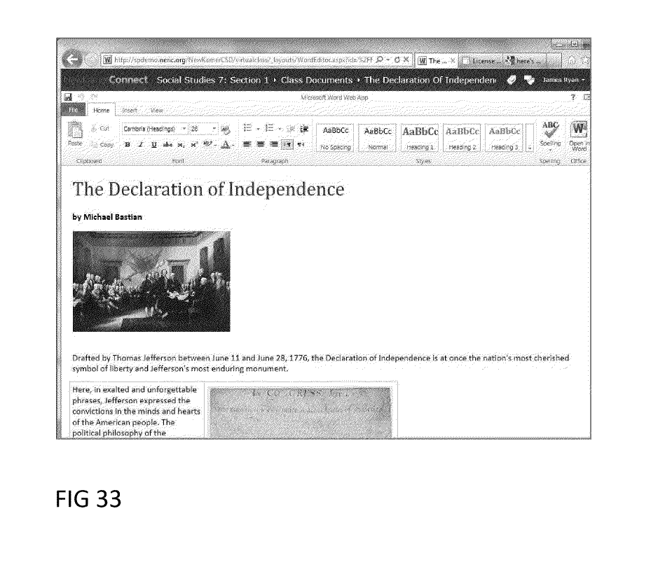

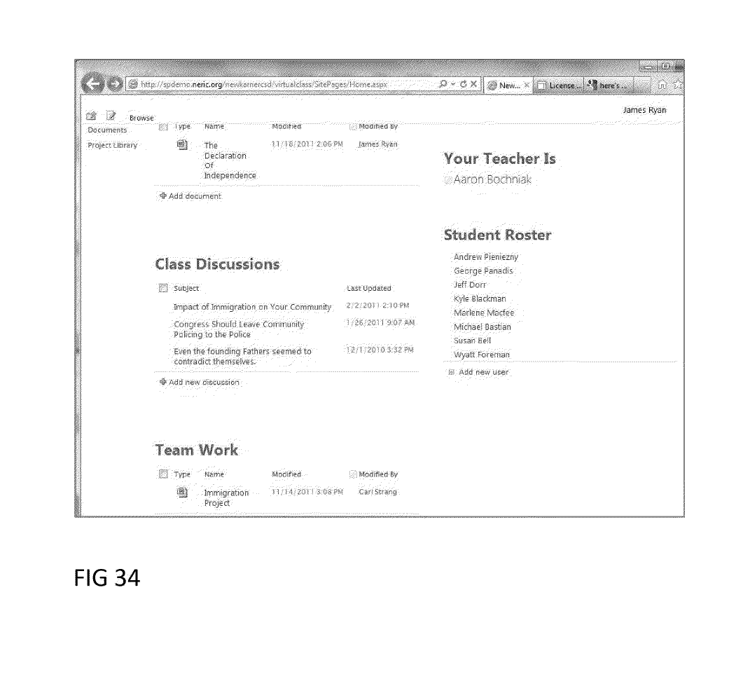

In an embodiment of the present invention, data is available through the GUI on a classroom level. FIGS. 31-39 illustrate an on-line learning environment. In this embodiment, each class automatically has a virtual classroom that is generated based on the class schedule in the Student Information System (an aforementioned data source). As viewed in FIGS. 31-39, the virtual classroom gives the teacher and students to several on-line learning tools, including, but not limited to: 1) class announcements (FIG. 31), 2) class documents that can be worked and collaborated on a thin client, including but not limited to an Internet browser (FIGS. 32 and 33), 3) class discussions (FIG. 34), 4) team work/projects (FIG. 34), 5) a calendar (FIGS. 34), and 6) a class list (FIG. 34).

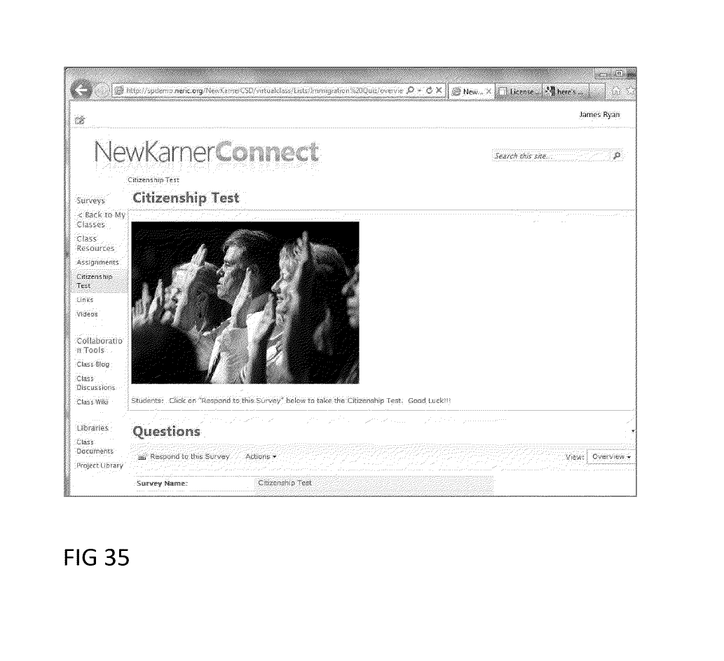

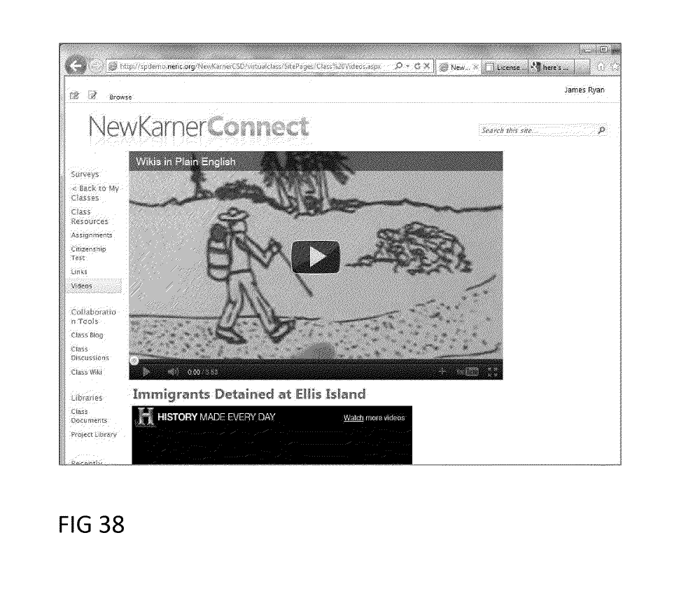

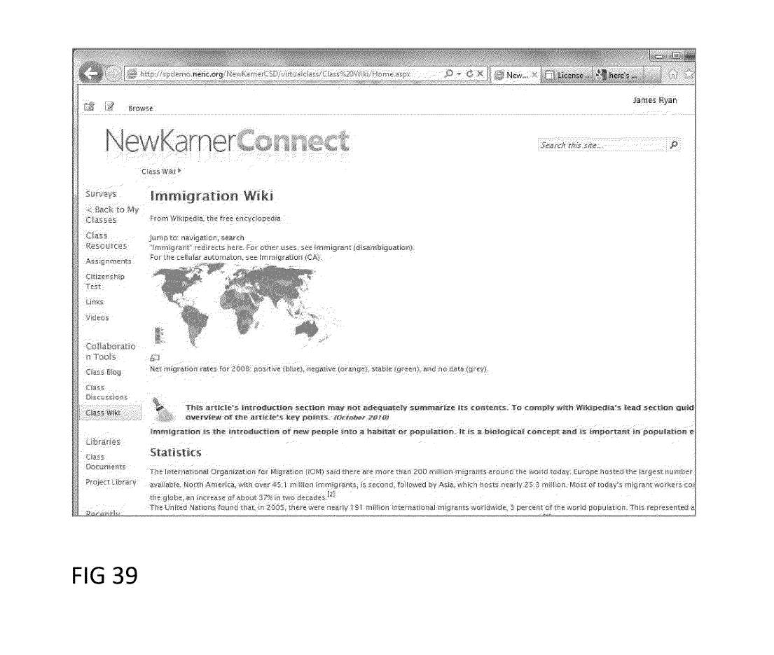

Utilizing this feature of this embodiment, users who are teachers can create quick formative assessments, quizzes and surveys for the class to take, with the ability to automatically aggregate responses, as seen in FIGS. 35, 36 and 37. As seen in FIG. 38, individuals with security permissions, such as teachers can, can link videos. These users can also create class/unit Wikis, as seen in FIG. 39, access class blogs, discussions, and/or project libraries.

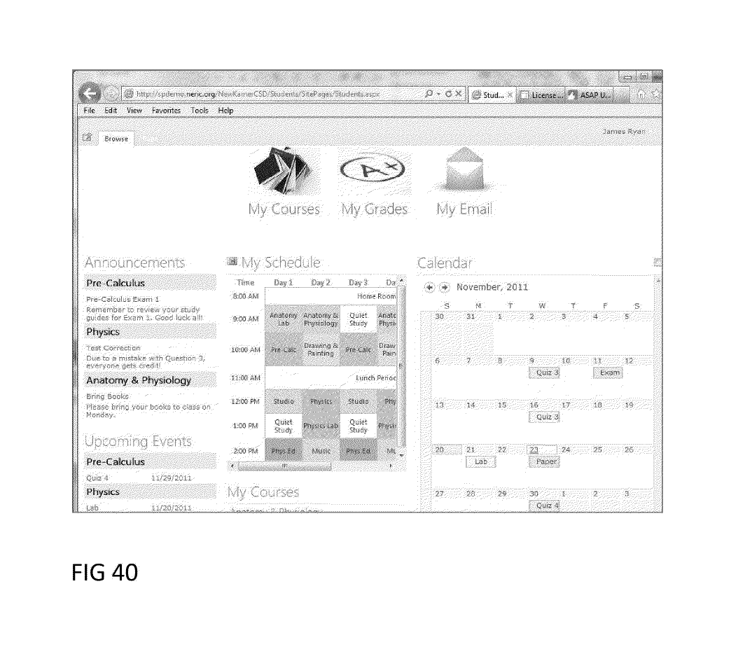

An embodiment of the present invention provides student-level users with specific features through a utilization and presentation of the various data sources. In an embodiment of the present system, students can access to their grades and reports, both current and historical, (which as aforementioned are also available to teachers). Both students and parents who use the system are granted permission to access the virtual classroom features discussed as well as individual student data, that is aggregated for student use, as displayed in FIG. 40. Utilizing the cloud technical architecture, an example of which was discussed in reference to FIG. 8, students can access a virtually private managed cloud drive to store documents and work.

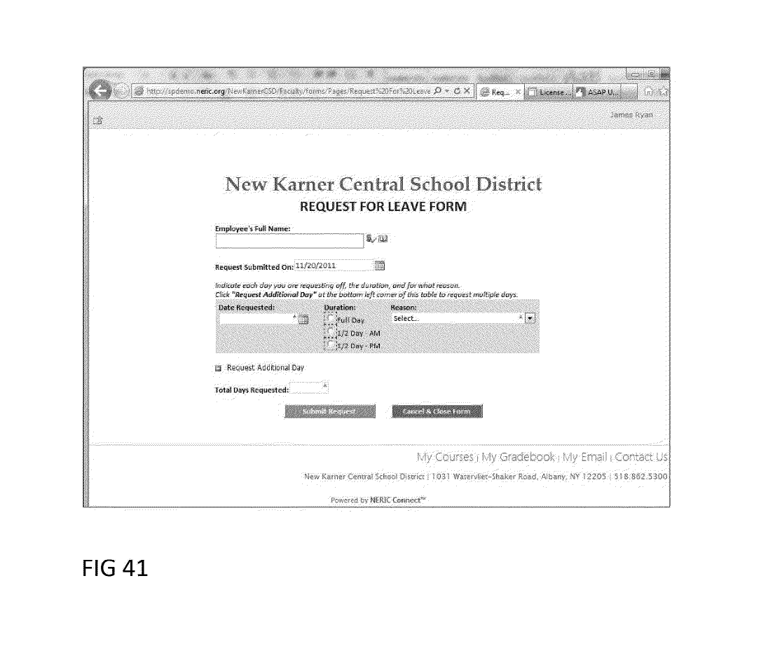

An embodiment of the present invention allows for schools to create forms that follow an approval chain or work flow. FIG. 41 illustrates a Leave Request form, as an example of such a form. Other forms created with this feature include, but are not limited to requisitions, field trip and/or conference travel requests.

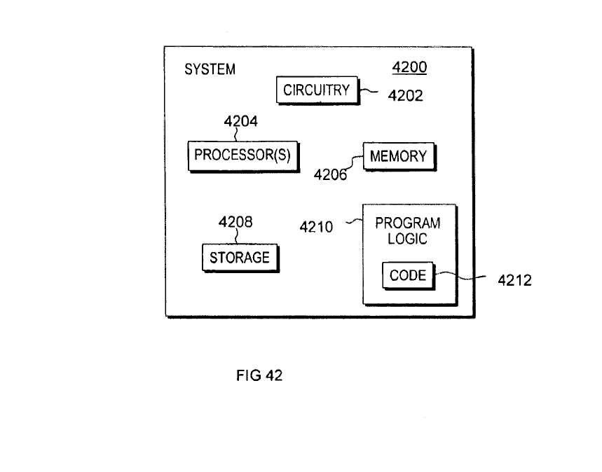

FIG. 42 illustrates a block diagram of a resource 4200 in user terminals 110a-110e, server 120, and/or the resources of the data storage and processing system, including, but not limited to server-side proxy component 841, and back-end computers 842a, 842b, 842n, which is part of the technical architecture of certain embodiments of the technique. The resource 4200 may include a circuitry 4202 that may in certain embodiments include a microprocessor 4204. The computer system 4200 may also include a memory 4206 (e.g., a volatile memory device), and storage 4208. The storage 4208 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 4208 may comprise an internal storage device, an attached storage device and/or a network accessible storage device. The system 4200 may include a program logic 4210 including code 4212 that may be loaded into the memory 4206 and executed by the microprocessor 4204 or circuitry 4202.

In certain embodiments, the program logic 4210 including code 4212 may be stored in the storage 4208, or memory 4206. In certain other embodiments, the program logic 4210 may be implemented in the circuitry 4202. Therefore, while FIG. 42 shows the program logic 4210 separately from the other elements, the program logic 4210 may be implemented in the memory 4206 and/or the circuitry 4202.

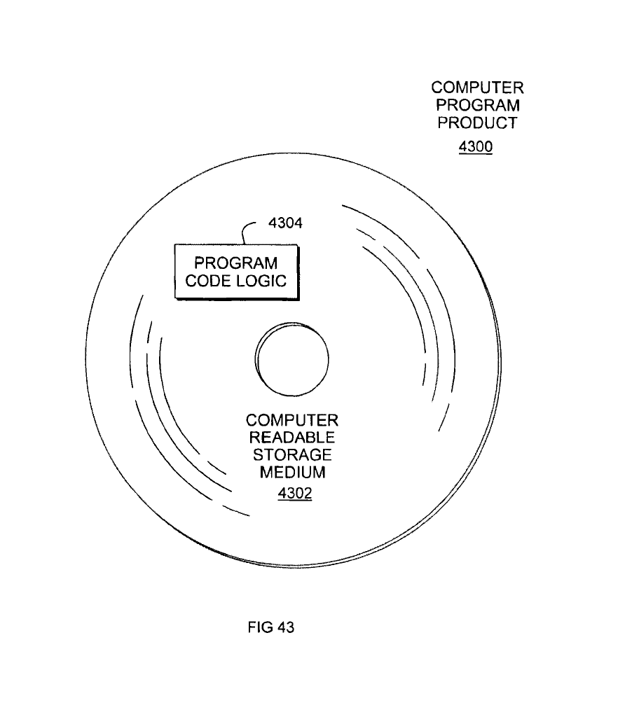

Using the processing resources of a resource 4200 to execute software, computer-readable code or instructions, does not limit where this code is can be stored. Referring to FIG. 43, in one example, a computer program product 4300 includes, for instance, one or more non-transitory computer readable storage media 4302 to store computer readable program code means or logic 4304 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the technique has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for monitoring participants in an educational environment, the method comprising:
obtaining, by a processor, a set of predefined parameters;
obtaining, by said processor, a first data set and a second data set wherein said first data set comprises standardized summary data relating to said educational environment and said second data set comprises non-standardized granular data relating to said educational environment;
converting said second data set to a third data set wherein said third data set is a standardized data set generated by identifying relationships between a first value in said first data set and a second value in said second data set;
storing, by said processor, said first data set and said third data set in a consolidated data set on a memory resource; and
generating, by said processor, a notification when said data in said consolidated data set satisfies said set of predefined parameters.

2. The method of claim 1, wherein said consolidated data set comprises a unified data model.

3. The method of claim 1, wherein said notification comprises at least one of: a report, an email, an SMS, a text message, an instant message.

4. The method of claim 1, wherein said first data set comprises data from the Statewide Data Warehouse.

5. The method of claim 1, wherein said second data set comprises data from at least one of: Student Information System, Special Education System, Intervention System, School Lunch System, Transportation System, Formative, Diagnostic & Summative Assessments, Teacher Observations, anecdotal journal comments related to student progress, behavior and reflections, student, parent and teacher performance goals.

6. The method of claim 1, wherein said consolidated data set comprises a plurality of modules.

7. The method of claims 1, wherein said set of predefined parameters comprise a threshold for the amount of times a given event can occur within a given period of time.

8. The method of claim 7, wherein said given event comprises one of: an attendance event, a disciplinary event, a test score.

9. The method of claim 1, further comprising:
obtaining, by said processor, a plurality of data sets comprising non-standardized granular data relating to said educational environment;
converting said plurality of data sets to a standardized plurality of data sets wherein said standardized plurality of data sets are generated by identifying relationships between a third value in said first data set and a coordinating value in each of said plurality of data sets; and
storing, by said processor, said standardized plurality of data sets in said consolidated data set on said memory resource.

10. A computer program product for monitoring participants in an educational environment, the computer program product comprising:
a computer readable storage medium readable by a processing circuit and storing instructions for execution by the processing circuit for performing a method comprising:
obtaining, by a processor, a set of predefined parameters;
obtaining, by said processor, a first data set and a second data set wherein said first data set comprises standardized summary data relating to said educational environment and said second data set comprises non-standardized granular data relating to said educational environment;
converting said second data set to a third data set wherein said third data set is a standardized data set generated by identifying relationships between a first value in said first data set and a second value in said second data set;
storing, by said processor, said first data set and said third data set in a consolidated data set on a memory resource; and
generating, by said processor, a notification when said data in said consolidated data set satisfies said set of predefined parameters.

11. The computer program product of claim 10, wherein said consolidated data set comprises a unified data model.

12. The computer program product of claim 10, wherein said notification comprises at least one of: a report, an email, an SMS, a text message, an instant message.

13. The computer program product of claim 10, wherein said first data set comprises data from the Statewide Data Warehouse.

14. The computer program product of claim 10, wherein said second data set comprises data from at least one of: Student Information System, Special Education System, Intervention System, School Lunch System, Transportation System, Formative, Diagnostic & Summative Assessments, Teacher Observations, anecdotal journal comments related to student progress, behavior and reflections, student, parent and teacher performance goals.

15. The computer program product of claim 10, wherein said consolidated data set comprises a plurality of modules.

16. The computer program product of claim 10, wherein said set of predefined parameters comprise a threshold for the amount of times a given event can occur within a given period of time.

17. The computer program product of claim 16, wherein said given event comprises one of: an attendance event, a disciplinary event, a test score.

18. The computer program product of claim 10, further comprising:
obtaining, by said processor, a plurality of data sets comprising non-standardized granular data relating to said educational environment;
converting said plurality of data sets to a standardized plurality of data sets wherein said standardized plurality of data sets are generated by identifying relationships between a third value in said first data set and a coordinating value in each of said plurality of data sets; and
storing, by said processor, said standardized plurality of data sets in said consolidated data set on said memory resource.

19. A computer system for monitoring participants in an educational environment, said computer system comprising a server-side proxy component and at least two back-end computers;
wherein said server-side proxy component is configured, responsive to obtaining a request, to select a back-end computer to forward said request to, based on one or more of: a pre-defined rule, load estimates for said at least two computers, estimated network throughputs across network paths to each of said at least two computers;
wherein said selected back-end computer is configured, responsive to receiving said request, said request comprising a set of predefined parameters, to retain said set of predefined parameters in a memory resource;
wherein said selected back-end computer is further configured, to obtain a first data set and a second data set, wherein said first data set comprises standardized summary data relating to said educational environment and said second data set comprises non-standardized granular data relating to said educational environment;
wherein said selected back-end computer is further configured, responsive to obtaining said first data set and said second data, to convert said second data set to a third data set, wherein said third data set is a standardized data set generated, by identifying relationships between a first value in said first data set and a second value in said second data set;
wherein said selected back-end computer is further configured, responsive to converting said second data set, to store said first data set and said third data set in a consolidated data set on said memory resource; and
wherein said selected back-end computer is further configured to generate a notification when said data in said consolidated data set satisfies said set of predefined parameters.

20. The computer system of claim 19, wherein said selected back-end computer is further configured to obtain a plurality of data sets comprising non-standardized granular data relating to said educational environment;
wherein said selected back-end computer is further configured to convert said plurality of data sets to a standardized plurality of data sets wherein said standardized plurality of data sets are generated by identifying relationships between a third value in said first data set and a coordinating value in each of said plurality of data sets; and
wherein said selected back-end computer is further configured to store said standardized plurality of data sets in said consolidated data set on said memory resource.
